(19) United States
(12) Patent Application Publication
(10) Pub. No.: US 2024/0298276 A1
(43) Pub. Date: Sep. 5, 2024

(54) ANTENNA ARRAY GAIN SETTINGS BASED ON POLARIZATION DIVERSITY

(71) Applicant: QUALCOMM Incorporated, San Diego, CA (US)

(72) Inventors: Kapil RAI, Sunnyvale, CA (US); Suresh CHANDRASEKARAN, Kanchipuram (IN); Michael Richard GREEN, Needham, MA (US); Tevfik YUCEK, San Jose, CA (US)

(21) Appl. No.: 18/573,326

(22) PCT Filed: Jul. 18, 2022
(86) PCT No.: PCT/US2022/037496

§ 371 Date: Dec. 21, 2023

(30) Foreign Application Priority Data
Aug. 25, 2021 (IN) 202121038574

(51) Int. Cl. H04W 52/42; H04B 7/10

(52) U.S. Cl. CPC H04W 52/42; H04B 7/10

(57) ABSTRACT

This disclosure provides methods, devices, and systems for selecting antenna power levels based on polarization diversity. For example, a wireless communication device can determine first and second transmission power levels for a first set of one or more antennas and a second set of one or more antennas, respectively, based on a polarization diversity setting for a wireless communication device that is based on a first orientation of the first set of antenna(s) being orthogonal to a second orientation of the second set of antenna(s). The wireless communication device can transmit, to a target device, first signals at the first transmission power levels using the first set of antenna(s) and second signals at the second transmission power levels using the second set of antenna(s). The first signals are cross-polarized from the second signals based on the first orientation being orthogonal to the second orientation.

### CROSS-REFERENCE TO RELATED APPLICATIONS

This application for Patent is a 371 application of international Patent Application PCT/US2022/037496, filed Jul. 18, 2022, which claims priority to Indian Patent Application 202121038574, filed Aug. 25, 2021, which are hereby incorporated by referenced in their entirety and for all purposes.

### TECHNICAL FIELD

This disclosure relates generally to wireless communication, and more specifically, to power transmission management for multiple-input multiple-output (MIMO) and smart antenna systems operating in channels with power or power spectral density (PSD) restrictions.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

When a wireless communication device such as an AP or a STA has data to transmit, the wireless communication device transmissions may be subject to power limitations. Such transmission limits can include both power spectral density limitations, as well as effective isotropic radiated power (EIRP) limitations. For arrays of antennas, power limitations can be based on a total power being transmitted on all antennas in a given channel, and can further be based on whether transmissions on different antennas are correlated or uncorrelated. Because the transmit power is directly associated with key device characteristics, such as coverage area for a device to receive transmissions from an access point (AP) or wireless station (STA), selection of gain settings associated with power transmission can greatly impact device performance.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. The method includes: determining first transmission power levels for a first set of one or more antennas and second transmission power levels for a second set of one or more antennas based on a polarization diversity setting for a wireless communication device, the polarization diversity setting being based on a first orientation of the first set of one or more antennas being orthogonal to a second orientation of the second set of one or more antennas; transmitting, to a target device, first signals at the first transmission power levels using the first set of one or more antennas; and transmitting, to the target device, second signals at the second transmission power levels using the second set of one or more antennas, the first signals being cross-polarized from the second signals based on the first orientation being orthogonal to the second orientation.

Another innovative aspect of the subject matter described in this disclosure can be implemented in a wireless communication device. The wireless communication device includes: at least one modem; a first set of one or more antennas communicatively coupled to the at least one modem and having a first orientation; a second set of one or more antennas communicatively coupled to the at least one modem and having a second orientation that is orthogonal to the first orientation; at least one processor communicatively coupled with the at least one modem; and at least one memory communicatively coupled with the at least one processor and storing processor-readable code that, when executed by the at least one processor in conjunction with the at least one modem, that is configured to: determine first transmission power levels for the first set of one or more antennas and second transmission power levels for the second set of one or more antennas based on a polarization diversity setting for the wireless communication device, the polarization diversity setting being based on the first orientation of the first set of one or more antennas being orthogonal to the second orientation of the second set of one or more antennas; transmit, to a target device, first signals at the first transmission power levels using the first set of one or more antennas; and transmit, to the target device, second signals at the second transmission power levels using the second set of one or more antennas, the first signals being cross-polarized from the second signals based on the first orientation being orthogonal to the second orientation.

In some implementations, the methods and wireless communication devices may be configured to: determine the polarization diversity setting for one or more communications, the polarization diversity setting indicating that the first signals and the second signals are cross-polarized signals; determine antenna assignments for one or more communications at least in part by assigning the first set of one or more antennas and the second set of one or more antennas to the one or more communications; and select the first transmission power levels for the first set of one or more antennas and the second transmission power levels for the second set of one or more antennas based on the polarization diversity setting and the antenna assignments.

In some implementations, the methods and wireless communication devices may be configured to: determine a first array gain for the first set of one or more antennas based on the antenna assignments; determine a second array gain for the second set of one or more antennas based on the antenna assignments; and determine a transmission power level for each antenna of the first set of one or more antennas based on the first array gain and for each antenna of the second set of one or more antennas based in the second array gain.

Additional aspects are included in the detailed description below.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows a pictorial diagram of an example wireless communication network that can be used to implement aspects described herein.

FIG. 2A shows an example protocol data unit (PDU) usable for communications between an access point (AP) and one or more stations (STAs).

FIG. 2B shows an example field in the PDU of FIG. 2A.

FIG. 3A shows an example PHY layer convergence protocol (PLCP) protocol data unit (PPDU) usable for communications between an AP and one or more STAs.

FIG. 3B shows another example PPDU usable for communications between an AP and one or more STAs.

FIG. 4 shows a block diagram of an example wireless communication device that can be used to implement aspects described herein.

FIG. 5A shows a block diagram of an example access point (AP) that can be used to implement aspects described herein.

FIG. 5B shows a block diagram of an example station (STA) that can be used to implement aspects described herein.

FIG. 6 illustrates aspects of orthogonal transmissions from antennas in a device in accordance with aspects described herein.

FIG. 7A shows example layers of a network interface including a physical (PHY) layer and a media access control (MAC) layer that can be used for managing device transmissions in accordance with some aspects described herein.

FIG. 7B shows example aspects of interactions between hardware and firmware component to support selection of power levels based on polarization diversity in accordance with aspects described herein.

FIG. 8 shows a flowchart illustrating an example process for selection of antenna power levels based on polarization diversity in accordance with aspects described herein.

FIG. 9A shows a flowchart illustrating an example process for selection of antenna power levels based on polarization diversity in accordance with aspects described herein.

FIG. 9B shows a block diagram of an example wireless communication device that supports antenna array gain settings according to some implementations.

FIG. 10 illustrates an example device with antennas configured for polarization diversity in accordance with aspects described herein.

FIG. 11A illustrates aspects of a device configured for antenna array gain setting based on polarization diversity according to some implementations.

FIG. 11B illustrates aspects of a device configured for antenna array gain setting based on polarization diversity according to some implementations.

FIG. 12 illustrates system operation including a transmitting device configured for antenna array gain setting based on polarization diversity and a receiving device configured to receive transmissions from the transmitting device according to some implementations.

FIG. 13 illustrates an example device with antenna arrays configured for polarization diversity in accordance with aspects described herein.

FIG. 14 illustrates aspects of a device configured for antenna array gain setting based on polarization diversity according to some implementations.

FIG. 15 illustrates system operation including a transmitting device configured for antenna array gain setting based on polarization diversity and a receiving device configured to receive transmissions from the transmitting device according to some implementations.

Like reference numbers and designations in the various drawings indicate like elements.

### DETAILED DESCRIPTION

The following description is directed to some particular examples for the purposes of describing aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described aspects can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU)-MIMO. The described aspects also can be implemented using other wireless communication protocols or RF signals suitable for use in one or more of a wireless personal area network (WPAN), a wireless local area network (WLAN), a wireless wide area network (WWAN), or an internet of things (IOT) network.

The above wireless communication systems are subject to regulatory limits on the amount of power transmitted by devices in a system. Such limits can include specific limitations on the amount of power transmitted into frequency channels (e.g., power spectral density limits) as well as limitations on power radiated by antennas (e.g., equivalent isotopically radiated power (EIRP)). For antenna arrays or multiple antenna systems, the power radiated by each antenna into a given channel is considered for such power limitations. For highly correlated signals on different antennas being transmitted at the same time, the transmitters must reduce per-antenna power to meet power spectral density (PSD) and EIRP limits, as the correlated signals can combine to exceed the limits. Beamformed or steered signals are examples of correlated signals transmitted during a shared time period that result in a reduction of per-antenna power transmission. The power limits result in certain aspects of performance gains from MIMO transmission being nullified, as the antenna array gain from the use of multiple antennas is offset by reduced power to the individual antennas to meet PSD and EIRP limits.

By contrast, separate signals where the data in the signals are not statistically related (e.g., uncorrelated) do not combine in the wireless transmission medium in the same way as correlated signals, and so the above described PSD and EIRP limits on arrays of antennas are associated with higher antenna array gain settings and higher transmit power when matched to uncorrelated signals. Further, when antennas in an array are mutually orthogonal (e.g., transmitting in a geometry distinct from each other, such as in orthogonal x, y, and z planes of a cartesian coordinate system), the signals can be treated as uncorrelated, even if the data of the signals is identical or highly statistically similar. When the signals reflect of surfaces in an environment, the signals lose their polarization. The loss of polarization allows the signals to be received as correlated signals at a target device (e.g., after the reflections), while the signals are uncorrelated at the transmitting device (e.g., before the reflections.)

Various aspects relate generally to the use of mutually orthogonal MIMO antenna systems by a wireless communication device (e.g., an access point (AP) or a station (STA)) for transmitting cross-polarized signals (also referred to as orthogonally polarized signals) from mutually orthogonal antennas at the wireless communication device. For example, the wireless communication device can use the cross-polarized signals for performing beamforming or steering. In some examples, a wireless communication device can determine or select specific transmission power levels at individual antennas of a mutually-orthogonal antenna system for beamforming or steering transmissions by determining that polarization diversity is supported (e.g., mutually-orthogonal antennas are available for use), and then determining antenna array gain settings from static (e.g., a control table) or dynamic (e.g., computed per-packet) elements. The wireless communication can then determine the transmission power levels at the individual antennas of the mutually orthogonal antenna system using the gain settings.

As noted above, in some aspects, a wireless communication device (e.g., an AP or STA) can select antenna array gain settings for polarization diversity using a control table. The control table can include entries for each unique combination of transmitters (e.g., antennas), simultaneous streams of data, and one or more band channels for when polarization diversity is enabled and disabled. An example of a control table is illustrated in table 2 below. In some aspects, a wireless communication device can set an array gain using both static values from a control table and dynamic array gain contributions that are contributed on a per packet bases for streams of data. For implementations with multiple antennas in a given direction (e.g., non-orthogonal antennas), the wireless communication device can use masks that indicate how signals are allocated among the different antennas. In one illustrative example, for a wireless communication device with eight antennas divided among three orthogonal directions, a first direction can be associated with three antennas, a second direction can be associated with three antennas, and a third direction can be associated with the remaining two antennas. A control table and associated masks can indicate how given signals are transmitted. For example, with polarization diversity enabled for the wireless communication device with the eight antennas, the wireless communication device can configure (e.g., based on the control table and associated masks) the transmission of three signals (e.g., each to be transmitted on a unique channel or frequency range). The wireless communication device can allocate the three signals among the eight antennas so that two of the signals are each transmitted using three antennas each (e.g., one from each direction) and the third signal is transmitted using the two remaining orthogonal antennas. With such an allocation, each of the three signals are transmitted on groups of mutually orthogonal antennas such that a back off is not needed in order to comply with power limits for the corresponding channel used for each signal. The wireless communication device can transmit the first signal on three antennas, each mutually orthogonal (e.g., an Hx, an Hy, and a Vx orientation), so that each antenna used to transmit the first signal has a different orientation. The wireless communication device can transmit the second signal on three additional antennas, different than the three antennas used for the first signal, with each of the three additional antennas also being mutually orthogonal from each other (e.g., an Hx, an Hy, and a Vx orientation). The wireless communication device can transmit the third signal using the two remaining unused antennas of the device's eight antennas, which are orthogonal from each other (e.g., an Hx and Hy orientation, an Hx and Vx orientation, or an Hy and Vx orientation).

Particular aspects of the subject matter described in this disclosure can be implemented to realize one or more of the following potential advantages. In some examples, by using mutually orthogonal antennas for transmitting cross-polarized (or orthogonally polarized) signals, a wireless communication device (e.g., an AP or STA) can increase transmission power while conforming with PSD and EIRP limits, such as those described above. For example, by transmitting the correlated signals on mutually orthogonal antennas, a wireless communication device can maintain the power benefits of multiple antennas while complying with PSD and EIRP limits due to the wireless signals being uncorrelated near the wireless communication device (e.g., prior to reflections). Such transmissions improve the performance of a wireless communication device (e.g., signal coverage, throughput, etc.) while maintaining compliance with wireless communication system power limits. According to aspects described herein, a wireless communication device can transmit correlated data on different antennas in a manner that can ensure that the wireless signals are not correlated near the wireless communication device, due to the polarization of the antennas being mutually orthogonal at the wireless communication device. In such aspects, at the wireless communication device where the PSD and EIRP values are most problematic, the wireless transmissions on the mutually orthogonal antennas do not interact in a problematic fashion. Based on such aspects, a receiving device can receive the cross-polarized or orthogonally polarized signals in the same fashion as a directly beamformed signal (e.g., due to environmental reflections). For instance, a receiving device can receive reflected transmissions of data correlated signals transmitted by orthogonal antennas of the mutually-orthogonal antenna system and can use the received transmissions as a beamformed signal, since the polarization of the transmitted signals is lost as the signals are reflected. Communications systems integrating such aspects can have increased coverage area (e.g., with fewer devices needed for a given coverage area) and can have improved communication performance (e.g., received signal strength indication performance or MIMO channel correlation performance) in environments with manifold reflections (e.g., indoor environments) involving rich scattering with significant numbers of reflective surfaces where orthogonally transmitted signals are reflected to a receiving device as a received MIMO communication.

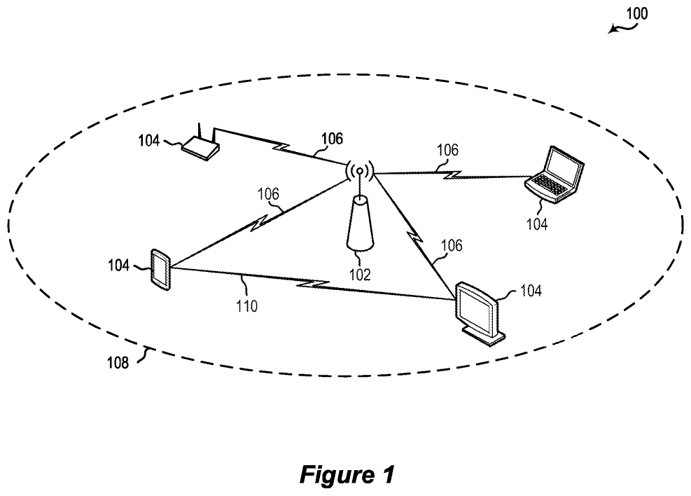

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples.

A single AP 102 and an associated set of STAs 104 may be referred to as a basic service set (BSS), which is managed by the respective AP 102. FIG. 1 shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. After association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such aspects, while the STAs 104 may be capable of communicating with each other through the AP 102 using communication links 108, STAs 104 also can communicate directly with each other via direct wireless links 110. Two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple channels (e.g., 20 megahertz (MHz) channels, 160 MHz channels, etc.).

As described above, some communication systems can be configured for multiple-input-multiple output (MIMO) operation to increase the capacity of a radio link using multiple transmission antennas and receiving antennas to exploit multipath propagation. In MIMO operation, multiple signals are transmitted simultaneously over a single radio channel (e.g., a defined frequency range). As described herein, MIMO transmissions using mutually orthogonal antenna placements can be performed with the signals on the orthogonal antennas treated as uncorrelated signals due to the positioning of the antennas.

Similarly, “smart antenna” systems can use beamforming or spatial filtering for directional signal transmission. Such smart antenna array systems transmit correlated signals on separate antennas within the “smart antenna” system, relying on constructive and destructive interference patterns to provide desired signal reception characteristics. As described herein, such signals for beamforming when sent on antennas with a shared direction (e.g., non-orthogonal) are subject to power reductions due to the separate antennas sending correlated signals on a single channel. Such signals, when sent on a shared channel using mutually orthogonal antennas, can be treated as uncorrelated signals, even if the data in the signals is correlated, due to the characteristics of transmission over mutually orthogonal antennas. Polarization diversity as described herein can be used with both MIMO systems and “smart antenna” systems (e.g., using digital or hybrid beamforming) to improve communication system performance, particularly in indoor environments, or environments when reflections are sufficient to create reflections from the mutually orthogonal antennas that will arrive at a target receiver.

As described above, the data in such communication systems can be structured as PPDUs. Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

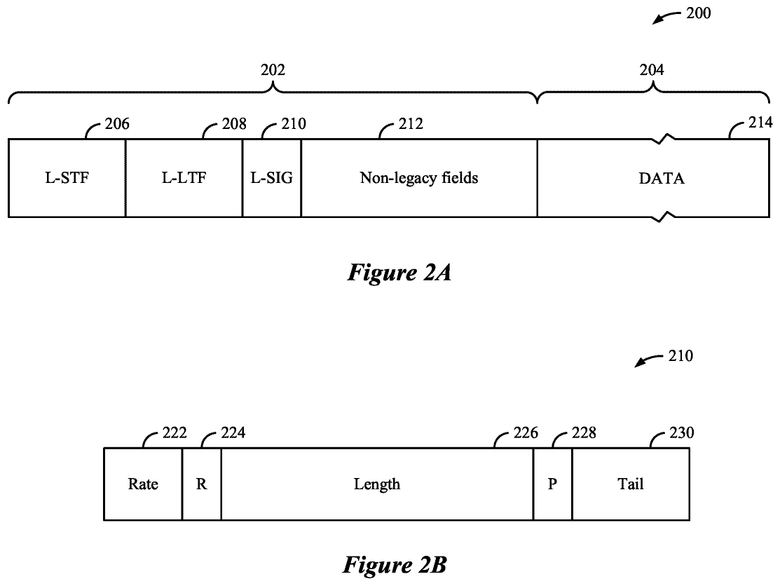

FIG. 2A shows an example protocol data unit (PDU) 200 usable for wireless communication between an AP 102 and one or more STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two binary phase-shift keying (BPSK) symbols, a legacy long training field (L-LTF) 208, which may consist of two BPSK symbols, and a legacy signal field (L-SIG) 210, which may consist of orthogonal frequency division multiplexing (OFDM) symbols with BPSK modulated subcarriers. The legacy portion of the preamble 202 may be configured according to the IEEE 802.11a wireless communication protocol standard. The preamble 202 may also include a non-legacy portion including one or more non-legacy fields 212, for example, conforming to an IEEE wireless communication protocol such as the IEEE 802.11ac, 802.11ax, 802.11be or later wireless communication protocol protocols.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine a duration of the PDU and to use the determined duration to avoid transmitting on top of the PDU. For example, the L-STF 206, the L-LTF 208 and the L-SIG 210 may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of medium access control (MAC) protocol data units (MPDUs) or an aggregated MPDU (A-MPDU).

FIG. 2B shows an example L-SIG 210 in the PDU 200 of FIG. 2A. The L-SIG 210 includes a data rate field 222, a reserved bit 224, a length field 226, a parity bit 228, and a tail field 230. The data rate field 222 indicates a data rate (note that the data rate indicated in the data rate field 212 may not be the actual data rate of the data carried in the payload 204). The length field 226 indicates a length of the packet in units of, for example, symbols or bytes. The parity bit 228 may be used to detect bit errors. The tail field 230 includes tail bits that may be used by the receiving device to terminate operation of a decoder (for example, a Viterbi decoder). The receiving device may utilize the data rate and the length indicated in the data rate field 222 and the length field 226 to determine a duration of the packet in units of, for example, microseconds (μs) or other time units.

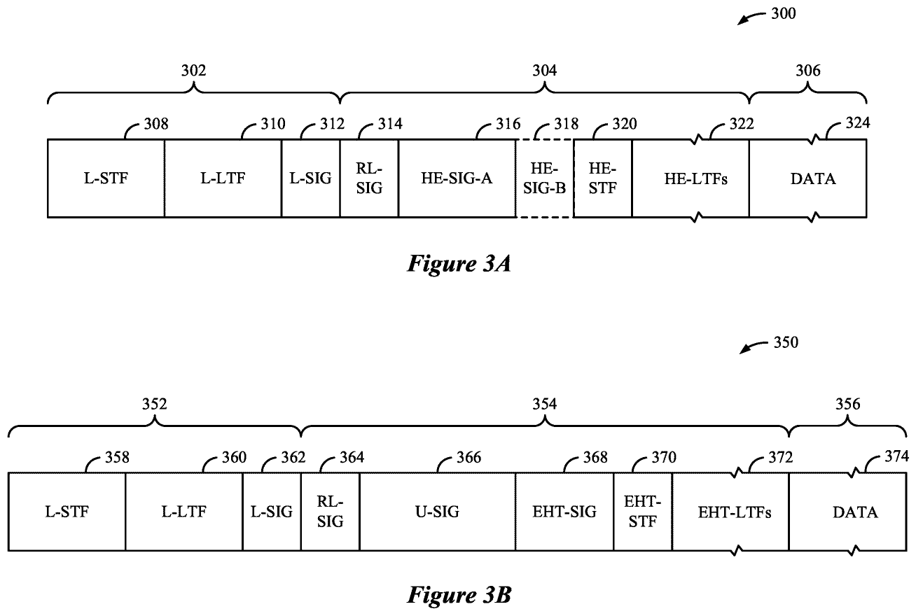

FIG. 3A shows an example PPDU 300 usable for wireless communication between an AP and one or more STAs. The PPDU 300 may be used for SU, OFDMA or MU-MIMO transmissions. The PPDU 300 may be formatted as a High Efficiency (HE) WLAN PPDU in accordance with the IEEE 802.11ax amendment to the IEEE 802.11 wireless communication protocol standard. The PPDU 300 includes a PHY preamble including a legacy portion 302 and a non-legacy portion 304. The PPDU 300 may further include a PHY payload 306 after the preamble, for example, in the form of a PSDU including a data field 324.

The legacy portion 302 of the preamble includes an L-STF 308, an L-LTF 310, and an L-SIG 312. The non-legacy portion 304 includes a repetition of L-SIG (RL-SIG) 314, a first HE signal field (HE-SIG-A) 316, an HE short training field (HE-STF) 320, and one or more HE long training fields (or symbols) (HE-LTFs) 322. For OFDMA or MU-MIMO communications, the second portion 304 further includes a second HE signal field (HE-SIG-B) 318 encoded separately from HE-SIG-A 316. HE-STF 320 may be used for timing and frequency tracking and AGC, and HE-LTF 322 may be used for more refined channel estimation. Like the L-STF 308, L-LTF 310, and L-SIG 312, the information in RL-SIG 314 and HE-SIG-A 316 may be duplicated and transmitted in each of the component 20 MHz channels in instances involving the use of a bonded channel. In contrast, the content in HE-SIG-B 318 may be unique to each 20 MHz channel and target specific STAs 104.

RL-SIG 314 may indicate to HE-compatible STAs 104 that the PPDU 300 is an HE PPDU. An AP 102 may use HE-SIG-A 316 to identify and inform multiple STAs 104 that the AP has scheduled UL or DL resources for them. For example, HE-SIG-A 316 may include a resource allocation subfield that indicates resource allocations for the identified STAs 104. HE-SIG-A 316 may be decoded by each HE-compatible STA 104 served by the AP 102. For MU transmissions, HE-SIG-A 316 further includes information usable by each identified STA 104 to decode an associated HE-SIG-B 318. For example, HE-SIG-A 316 may indicate the frame format, including locations and lengths of HE-SIG-Bs 318, available channel bandwidths and modulation and coding schemes (MCSs), among other examples. HE-SIG-A 316 also may include HE WLAN signaling information usable by STAs 104 other than the identified STAs 104.

HE-SIG-B 318 may carry STA-specific scheduling information such as, for example, STA-specific (or “user-specific”) MCS values and STA-specific RU allocation information. In the context of DL MU-OFDMA, such information enables the respective STAs 104 to identify and decode corresponding resource units (RUs) in the associated data field 324. Each HE-SIG-B 318 includes a common field and at least one STA-specific field. The common field can indicate RU allocations to multiple STAs 104 including RU assignments in the frequency domain, indicate which RUs are allocated for MU-MIMO transmissions and which RUs correspond to MU-OFDMA transmissions, and the number of users in allocations, among other examples. The common field may be encoded with common bits, CRC bits, and tail bits. The user-specific fields are assigned to particular STAs 104 and may be used to schedule specific RUs and to indicate the scheduling to other WLAN devices. Each user-specific field may include multiple user block fields. Each user block field may include two user fields that contain information for two respective STAs to decode their respective RU payloads in data field 324.

FIG. 3B shows another example PPDU 350 usable for wireless communication between an AP and one or more STAs. The PPDU 350 may be used for SU, OFDMA or MU-MIMO transmissions. The PPDU 350 may be formatted as an Extreme High Throughput (EHT) WLAN PPDU in accordance with the IEEE 802.11be amendment to the IEEE 802.11 wireless communication protocol standard, or may be formatted as a PPDU conforming to any later (post-EHT) version of a new wireless communication protocol conforming to a future IEEE 802.11 wireless communication protocol standard or other wireless communication standard. The PPDU 350 includes a PHY preamble including a legacy portion 352 and a non-legacy portion 354. The PPDU 350 may further include a PHY payload 356 after the preamble, for example, in the form of a PSDU including a data field 374.

The legacy portion 352 of the preamble includes an L-STF 358, an L-LTF 360, and an L-SIG 362. The non-legacy portion 354 of the preamble includes an RL-SIG 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). One or both of U-SIG 366 and EHT-SIG 368 may be structured as, and carry version-dependent information for, other wireless communication protocol versions beyond EHT. The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation. Like L-STF 358, L-LTF 360, and L-SIG 362, the information in U-SIG 366 and EHT-SIG 368 may be duplicated and transmitted in each of the component 20 MHz channels in instances involving the use of a bonded channel. In some implementations, EHT-SIG 368 may additionally or alternatively carry information in one or more non-primary 20 MHz channels that is different than the information carried in the primary 20 MHz channel.

EHT-SIG 368 may include one or more jointly encoded symbols and may be encoded in a different block from the block in which U-SIG 366 is encoded. EHT-SIG 368 may be used by an AP to identify and inform multiple STAs 104 that the AP has scheduled UL or DL resources for them. EHT-SIG 368 may be decoded by each compatible STA 104 served by the AP 102. EHT-SIG 368 may generally be used by a receiving device to interpret bits in the data field 374. For example, EHT-SIG 368 may include RU allocation information, spatial stream configuration information, and per-user signaling information such as MCSs, among other examples. EHT-SIG 368 may further include a cyclic redundancy check (CRC) (for example, four bits) and a tail (for example, 6 bits) that may be used for binary convolutional code (BCC). In some implementations, EHT-SIG 368 may include one or more code blocks that each include a CRC and a tail. In some aspects, each of the code blocks may be encoded separately by a device.

EHT-SIG 368 may carry STA-specific scheduling information such as, for example, user-specific MCS values and user-specific RU allocation information. EHT-SIG 368 may generally be used by a receiving device to interpret bits in the data field 374. In the context of DL MU-OFDMA, such information enables the respective STAs 104 to identify and decode corresponding RUs in the associated data field 374. Each EHT-SIG 368 may include a common field and at least one user-specific field. The common field can indicate RU distributions to multiple STAs 104, indicate the RU assignments in the frequency domain, indicate which RUs are allocated for MU-MIMO transmissions and which RUs correspond to MU-OFDMA transmissions, and the number of users in allocations, among other examples. The common field may be encoded with common bits, CRC bits, and tail bits. The user-specific fields are assigned to particular STAs 104 and may be used to schedule specific RUs and to indicate the scheduling to other WLAN devices. Each user-specific field may include multiple user block fields. Each user block field may include, for example, two user fields that contain information for two respective STAs to decode their respective RU payloads.

The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. For example, U-SIG 366 may be used by a receiving device to interpret bits in one or more of EHT-SIG 368 or the data field 374.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it must wait for a particular time and then contend for access to the wireless medium. In some aspects, the wireless communication device may be configured to implement the DCF through the use of carrier sense multiple access (CSMA) with collision avoidance (CA) (CSMA/CA) techniques and timing intervals. Before transmitting data, the wireless communication device may perform a clear channel assessment (CCA) and determine that the appropriate wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy. Virtual carrier sensing is accomplished via the use of a network allocation vector (NAV), an indicator of a time when the medium may next become idle. The NAV is reset each time a valid frame is received that is not addressed to the wireless communication device. The NAV effectively serves as a time duration that must elapse before the wireless communication device may contend for access even in the absence of a detected symbol or even if the detected energy is below the relevant threshold.

As described above, the DCF is implemented through the use of time intervals. These time intervals include the slot time (or “slot interval”) and the inter-frame space (IFS). The slot time is the basic unit of timing and may be determined based on one or more of a transmit-receive turnaround time, a channel sensing time, a propagation delay and a MAC processing time. Measurements for channel sensing are performed for each slot. All transmissions may begin at slot boundaries. Different varieties of IFS exist including the short IFS (SIFS), the distributed IFS (DIFS), the extended IFS (EIFS), and the arbitration IFS (AIFS). For example, the DIFS may be defined as the sum of the SIFS and two times the slot time. The values for the slot time and IFS may be provided by a suitable standard specification, such as one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be).

When the NAV reaches 0, the wireless communication device performs the physical carrier sensing. If the channel remains idle for the appropriate IFS (for example, the DIFS), the wireless communication device initiates a backoff timer, which represents a duration of time that the device must sense the medium to be idle before it is permitted to transmit. The backoff timer is decremented by one slot each time the medium is sensed to be idle during a corresponding slot interval. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has won contention for the wireless medium. If, on the other hand, one or more of the carrier sense mechanisms indicate that the channel is busy, a MAC controller within the wireless communication device will not permit transmission.

Each time the wireless communication devices generates a new PPDU for transmission in a new TXOP, it randomly selects a new backoff timer duration. The available distribution of the numbers that may be randomly selected for the backoff timer is referred to as the contention window (CW). If, when the backoff timer expires, the wireless communication device transmits the PPDU, but the medium is still busy, there may be a collision. If there is otherwise too much energy on the wireless channel resulting in a poor signal-to-noise ratio (SNR), the communication may be corrupted or otherwise not successfully received. In such instances, the wireless communication device may not receive a communication acknowledging the transmitted PDU within a timeout interval. The MAC may then increase the CW exponentially, for example, doubling it, and randomly select a new backoff timer duration from the CW before each attempted retransmission of the PPDU. Before each attempted retransmission, the wireless communication device may wait a duration of DIFS and, if the medium remains idle, then proceed to initiate the new backoff timer. There are different CW and TXOP durations for each of the four access categories (ACs): voice (AC_VO), video (AC_VI), background (AC_BK), and best effort (AC_BE). The different durations and access categories enable particular types of traffic to be prioritized in the network.

Some APs and STAs may be configured to implement spatial reuse techniques. For example, APs and STAs configured for communications using IEEE 802.11ax or 802.11be may be configured with a BSS color. APs associated with different BSSs may be associated with different BSS colors. If an AP or a STA detects a wireless packet from another wireless communication device while contending for access, the AP or STA may apply different contention parameters based on whether the wireless packet is transmitted by, or transmitted to, another wireless communication device within its BSS or from a wireless communication device from an overlapping BSS (OBSS), as determined by a BSS color indication in a preamble of the wireless packet. For example, if the BSS color associated with the wireless packet is the same as the BSS color of the AP or STA, the AP or STA may use a first received signal strength indication (RSSI) detection threshold when performing a CCA on the wireless channel. However, if the BSS color associated with the wireless packet is different than the BSS color of the AP or STA, the AP or STA may use a second RSSI detection threshold in lieu of using the first RSSI detection threshold when performing the CCA on the wireless channel, the second RSSI detection threshold being greater than the first RSSI detection threshold. In this way, the requirements for winning contention are relaxed when interfering transmissions are associated with an OBSS.

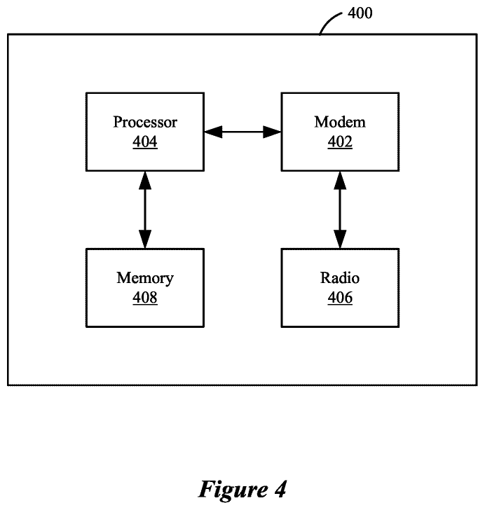

FIG. 4 shows a block diagram of an example wireless communication device 400. In some aspects, the wireless communication device 400 can be an example of a device for use in a STA such as one of the STAs 104 described above with reference to FIG. 1. In some aspects, the wireless communication device 400 can be an example of a device for use in an AP such as the AP 102 described above with reference to FIG. 1. The wireless communication device 400 is capable of transmitting and receiving wireless communications in the form of, for example, wireless packets. For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ay, 802.11ax, 802.11az, 802.11ba and 802.11be.

The wireless communication device 400 can be, or can include, a chip, system on chip (SoC), chipset, package or device that includes one or more modems 402, for example, a Wi-Fi (IEEE 802.11 compliant) modem. In some aspects, the one or more modems 402 (collectively “the modem 402”) additionally include a WWAN modem (for example, a 3GPP 4G LTE or 5G compliant modem). In some aspects, the wireless communication device 400 also includes one or more processors, processing blocks or processors 404 (collectively “the processor 404”) coupled with the modem 402. In some aspects, the wireless communication device 400 additionally includes one or more radios 406 (collectively “the radio 406”) coupled with the modem 402. In some aspects, the wireless communication device 400 further includes one or more memory blocks or elements (collectively “the memory 408”) coupled with the processor 404 or the modem 402.

The modem 402 can include an intelligent hardware block or device such as, for example, an application-specific integrated circuit (ASIC), among other examples. The modem 402 is generally configured to implement a PHY layer, and in some implementations, also a portion of a MAC layer (for example, a hardware portion of the MAC layer). For example, the modem 402 is configured to modulate packets and to output the modulated packets to the radio 406 for transmission over the wireless medium. The modem 402 is similarly configured to obtain modulated packets received by the radio 406 and to demodulate the packets to provide demodulated packets. In addition to a modulator and a demodulator, the modem 402 may further include digital signal processing (DSP) circuitry, automatic gain control (AGC) circuitry, a coder, a decoder, a multiplexer and a demultiplexer. For example, while in a transmission mode, data obtained from the processor 404 may be provided to an encoder, which encodes the data to provide coded bits. The coded bits may then be mapped to a number N_{SS} of spatial streams for spatial multiplexing or a number N_{STS} of space-time streams for space-time block coding (STBC). The coded bits in the streams may then be mapped to points in a modulation constellation (using a selected MCS) to provide modulated symbols. The modulated symbols in the respective spatial or space-time streams may be multiplexed, transformed via an inverse fast Fourier transform (IFFT) block, and subsequently provided to the DSP circuitry (for example, for Tx windowing and filtering). The digital signals may then be provided to a digital-to-analog converter (DAC). The resultant analog signals may then be provided to a frequency upconverter, and ultimately, the radio 406. In implementations involving beamforming, the modulated symbols in the respective spatial streams are precoded via a steering matrix prior to their provision to the IFFT block.

While in a reception mode, the DSP circuitry is configured to acquire a signal including modulated symbols received from the radio 406, for example, by detecting the presence of the signal and estimating the initial timing and frequency offsets. The DSP circuitry is further configured to digitally condition the signal, for example, using channel (narrowband) filtering and analog impairment conditioning (such as correcting for I/Q imbalance), and by applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may then be descrambled and provided to the MAC layer (the processor 404) for processing, evaluation or interpretation.

The radio 406 generally includes at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to one or more antennas. For example, in some aspects, the wireless communication device 400 can include, or be coupled with, multiple transmit antennas (each with a corresponding transmit chain) and multiple receive antennas (each with a corresponding receive chain). The symbols output from the modem 402 are provided to the radio 406, which then transmits the symbols via the coupled antennas. Similarly, symbols received via the antennas are obtained by the radio 406, which then provides the symbols to the modem 402.

The processor 404 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 404 processes information received through the radio 406 and the modem 402, and processes information to be output through the modem 402 and the radio 406 for transmission through the wireless medium. For example, the processor 404 may implement a control plane and at least a portion of a MAC layer configured to perform various operations related to the generation, transmission, reception and processing of MPDUs, frames or packets. In some aspects, the MAC layer is configured to generate MPDUs for provision to the PHY layer for coding, and to receive decoded information bits from the PHY layer for processing as MPDUs. The MAC layer may further be configured to allocate time and frequency resources, for example, for OFDMA, among other operations or techniques. In some aspects, the processor 404 may generally control the modem 402 to cause the modem (e.g., in conjunction with at least one processor) to perform various operations described above.

The memory 408 can include tangible storage media such as random-access memory (RAM) or read-only memory (ROM), or combinations thereof. The memory 408 also can store non-transitory processor- or computer-executable software (SW) code containing instructions that, when executed by the processor 404, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

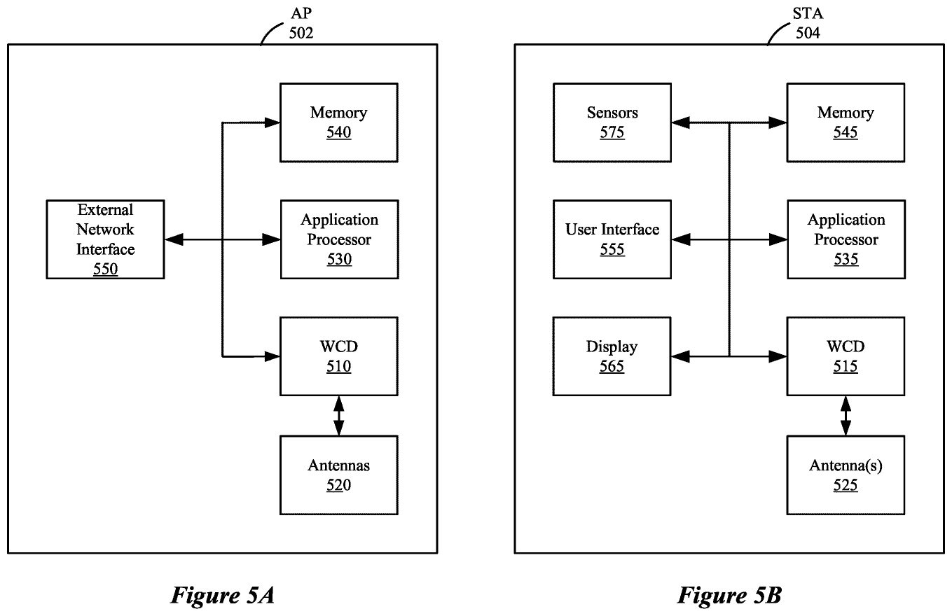

FIG. 5A shows a block diagram of an example AP 502. For example, the AP 502 can be an example implementation of the AP 102 described with reference to FIG. 1. The AP 502 includes a wireless communication device (WCD) 510 (although the AP 502 may itself also be referred to generally as a wireless communication device as used herein). For example, the wireless communication device 510 may be an example implementation of the wireless communication device 400 described with reference to FIG. 4. The AP 502 also includes multiple antennas 520 coupled with the wireless communication device 510 to transmit and receive wireless communications. In some aspects, the AP 502 additionally includes an application processor 530 coupled with the wireless communication device 510, and a memory 540 coupled with the application processor 530. The AP 502 further includes at least one external network interface 550 that enables the AP 502 to communicate with a core network or backhaul network to gain access to external networks including the Internet. For example, the external network interface 550 may include one or both of a wired (for example, Ethernet) network interface and a wireless network interface (such as a WWAN interface). Ones of the aforementioned components can communicate with other ones of the components directly or indirectly, over at least one bus. The AP 502 further includes a housing that encompasses the wireless communication device 510, the application processor 530, the memory 540, and at least portions of the antennas 520 and external network interface 550.

FIG. 5B shows a block diagram of an example STA 504. For example, the STA 504 can be an example implementation of the STA 104 described with reference to FIG. 1. The STA 504 includes a wireless communication device 515 (although the STA 504 may itself also be referred to generally as a wireless communication device as used herein). For example, the wireless communication device 515 may be an example implementation of the wireless communication device 400 described with reference to FIG. 4. The STA 504 also includes one or more antennas 525 coupled with the wireless communication device 515 to transmit and receive wireless communications. The STA 504 additionally includes an application processor 535 coupled with the wireless communication device 515, and a memory 545 coupled with the application processor 535. In some aspects, the STA 504 further includes a user interface (UI) 555 (such as a touchscreen or keypad) and a display 565, which may be integrated with the UI 555 to form a touchscreen display. In some aspects, the STA 504 may further include one or more sensors 575 such as, for example, one or more inertial sensors, accelerometers, temperature sensors, pressure sensors, or altitude sensors. Ones of the aforementioned components can communicate with other ones of the components directly or indirectly, over at least one bus. The STA 504 further includes a housing that encompasses the wireless communication device 515, the application processor 535, the memory 545, and at least portions of the antennas 525, UI 555, and display 565.

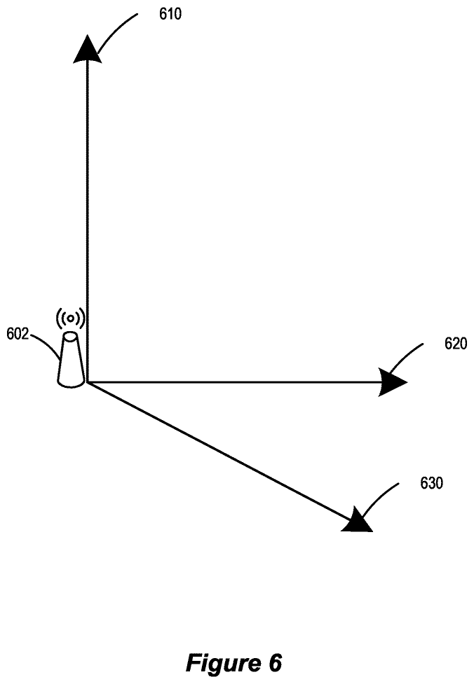

FIG. 6 shows an access point (AP) 602, which may be similar to the AP 102. The AP 602 includes multiple antennas oriented in separate mutually orthogonal directions. In some implementations of AP 602, first one or more antennas are oriented in a first orientation 610, and second one or more antennas are fixed in a second orientation 620. The orientation is not an absolute orientation, but a fixed orientation relative to the position of the other antennas to maintain the orthogonal positioning. If a device is moved, the absolute position of the antennas can change, but the relative orthogonal orientations relative to the other antennas remains fixed. AP 602 can include any number of antennas in a given orientation (e.g., 610, 620, 630), but antennas are present in at least two orthogonal orientations. In some aspects, third one or more antennas are also present and are fixed in a third orientation 630, such that orientations 610, 620, and 630 are mutually orthogonal, and a maximum of three mutually orthogonal orientations will be present. In some aspects, other antennas can be present in AP 602 and positioned in an orientation that is not mutually orthogonal with some or all of orientations 610, 620, and 630. Such an antenna will not be able to transmit signals that rely on the mutually orthogonal antenna position to treat transmitted signals as uncorrelated with simultaneous transmissions on the non-orthogonally positioned antennas (e.g., relative to the additional non-orthogonal antenna). Simultaneous transmission on such an antenna will require antenna array gain to be computed including the power of the non-orthogonal antenna.

Transmitting on such mutually orthogonally fixed antennas generates signals with different polarization, which prevents the signals (e.g., from MIMO or beamforming) from combining near the AP 602 (as a transmitting device). In indoor environments, however, where PSD considerations described above are the most sever, the polarized signals will scatter off of the indoor surfaces, causing the polarized signals to lose their polarization (e.g., the directional nature resulting from the mutually orthogonal fixed orientations 610, 620, and 630). When a receiver then receives the signals after the signals scatter off of surfaces in the environment, the receiver can combine the signals to achieve the performance gains described above, without the drawback of reduced transmission power associated with antenna array transmission of correlated signals.

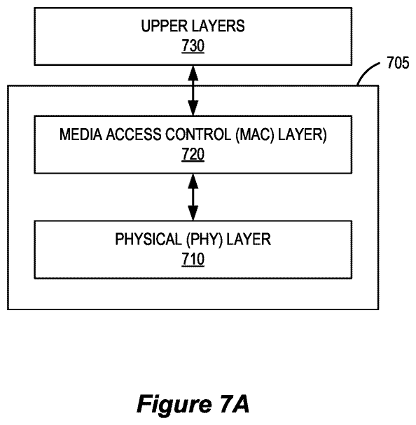

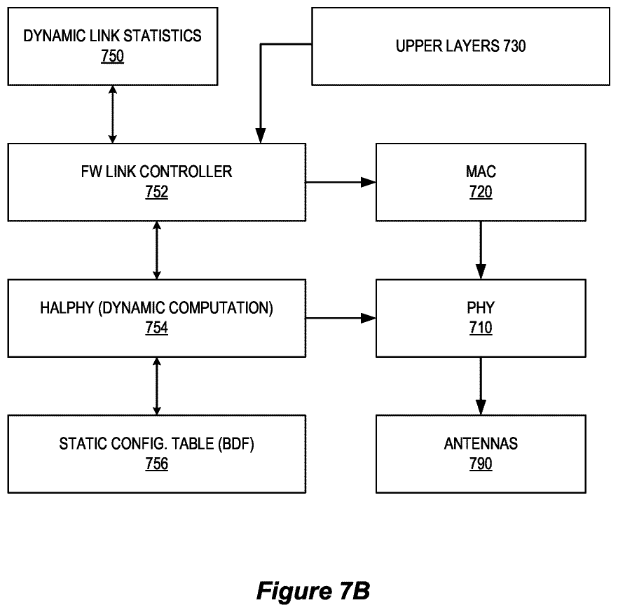

FIG. 7A shows example layers of a network interface in a wireless communication device, including a physical (PHY) layer 710 and a media access control (MAC) layer 720. The PHY layer 710 and the MAC layer 720 can be used for managing MIMO or smart antenna transmissions (e.g., antenna gain settings of the wireless communication device, use of static settings from a control table (e.g., a CTL table), etc.), dynamic physical layer settings (e.g., hardware abstraction layer (HALPHY) details for the PHY), firmware (FW) that interacts with the MAC layer to schedule outbound packets and transmission parameters (e.g., transmission rate, power, number of spatial streams, bandwidths, channels, etc.), and board description file (BDF) fields to control gain settings and associated transmission power to comply with PSD and EIRP limits. The PHY layer can manage device specific data such as a number of antennas for a device, polarization details and diversity masks for a device, control (e.g., CTL) table data in a BDF, or other data. The MAC layer 720 may manage data (that is to be transmitted) from upper layers 730 to the PHY layer 710, or may pass received data from the PHY layer 710 to the upper layers 730. The upper layers 730 may be part of the network interface 705 or may be part of a host device in which the network interface 705 is installed.

FIG. 7B shows examples of interactions between hardware and firmware components of a wireless communication device to support selection of power levels based on polarization diversity, in accordance with aspects described herein. As shown in FIGS. 7B, the wireless communication device can include (e.g., store, receiver, etc.) dynamic link statistics 750 that provide information for link control to firmware link controller 752. The wireless communication device can further include upper networking layers 730 that provide data packets for transmission to a firmware link controller 752 of the wireless communication device. The firmware link controller passes transmission parameters and polarization masks to HALPHY 754. HALPHY 754, as described above, performs dynamic computations for antenna power limits and associated gain settings. Associated parameters are passed from HALPHY 754 to BDF 756. The BDF 756 can use the parameters to determine static parameters and transmission power settings. The BDF 756 can send the static parameters and transmission power settings back to HALPHY 754. HALPHY 754 uses the static parameters and transmission power settings from BDF 756 to determine updated transmission parameters and to select specific polarization masks for use in transmission.

As described above, in some aspects, HALPHY 754 can use static parameters that are fixed for multiple sets of data. HALPHY 754 can dynamically compute revised transmission parameters on a per-packet basis (e.g., depending on specific characteristics associated with a data packet). The revised transmission parameters and selected polarization masks are passed from HALPHY 754 to firmware link controller 752. The firmware link controller then sends a data packet with the revised transmission parameters for the data packet and polarization diversity signaling information to MAC 720. MAC 720 uses the provided information to generate encapsulated packets that are provided to the PHY 710. The PHY 710 receives both the encapsulated packets from MAC 720 and configuration settings from HALPHY 754 (e.g., revised using the static parameters and dynamic parameters). The PHY 710 can use this data to generate signals for transmission via antennas 790, along with polarization diversity controls that are used in transmitting the signals. Additional details related to such controls and signaling are described below.

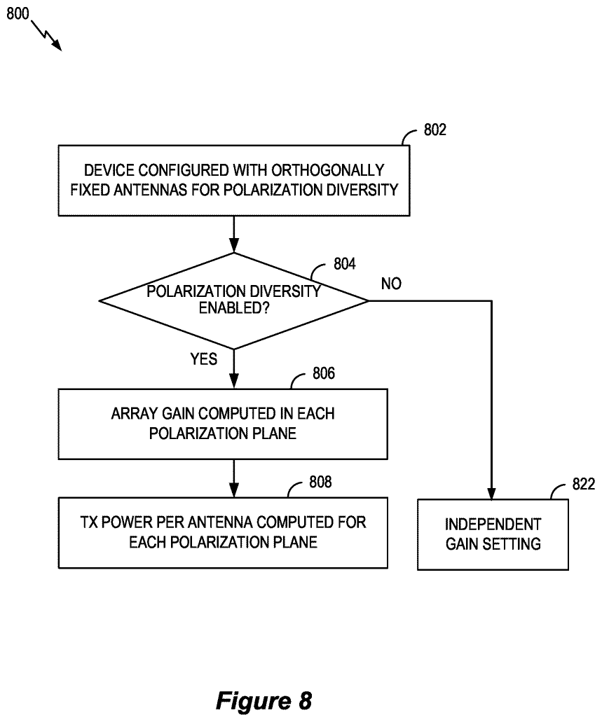

FIG. 8 shows a flowchart illustrating an example process 800 for device selection of antenna power levels based on polarization diversity according to some implementations. The process 800 illustrates operations that can be performed by a wireless communication device, such as AP 102 (or its components as described herein) or AP 602 (or its components as described herein), as part of transmissions in a communication system. For example, the process 800 may be performed by a wireless communication device, such as one of the STAs 104 described above with reference to FIG. 1, the AP 102 described above with reference to FIG. 1, the AP 602 described above with reference to FIG. 6, or other wireless communication device. In some aspects, the operations of the process 800 can be implemented as instructions in a computer readable storage medium, that, when executed by one or more processors, cause the device to perform the operations illustrated by in the flowchart of FIG. 8.

In some implementations, in block 802, the wireless communication device can be configured with orthogonally fixed antennas for polarization diversity. The wireless communication device can perform one or more operations to set transmission configuration settings for the wireless communication device. In some aspects, a control table of the wireless communication device (e.g., an AP or STA) can include power selection operations for multiple different device configurations. In such aspects, the wireless communication device can be configured with a particular setting to use a fixed set of data from the control table, and the wireless communication device will use an assigned subset of data from the control table during operation based on the configuration settings. The configuration can indicate transmission groupings of antennas which include or lack polarization diversity within an antenna grouping. The configuration can, for example, indicate the fixed polarization groupings of antennas for a device. For example, a control table can include settings for orthogonal antenna groups of 8 antennas as {6,1,1} {4,2,2} {3,3,2}, or any other such option. Configuration settings can be used to indicate which actual physical antenna configuration is present in a device, and to limit the device to using the appropriate settings for polarization diversity (e.g., orientations) among the antennas present in a given device.

In some implementations, in block 804, the wireless communication device can determine whether polarization diversity is enabled. For instance, when the wireless communication device is performing communication operations, if polarization diversity is not enabled by device configuration settings, in block 822, the wireless communication device can perform operations independent of polarization diversity operations (e.g., independent gain settings) in accordance with aspects described herein.

If, at block 804, the wireless communication device determines that polarization diversity is enabled, then for a given transmission configuration, the wireless communication device can compute an array gain in each polarization plane at block 806. In some implementations, in block 808, the wireless communication device can compute the transmission power for each antenna using the array gain for the corresponding polarization plane. In some aspects, the operations will result in all antennas having the same transmit power. In other aspects, such as when certain polarization planes (e.g., fixed orientations) are used to transmit correlated signals and other polarization planes are not, the per antenna transmission power set by a wireless communication device can vary greatly.

In one example of a 4-antenna device, three polarization planes (e.g., fixed orientations) are present: Hx, Hy, and Vz, with Vz having two antennas, and the other planes each having one antenna. For improved power transmission, the two antennas Vz1 and Vz2 need to carry separate uncorrelated signals. If correlated signals are carried on these two antennas, a power backoff is needed to meet power thresholds as described above. The Hx and Hy planes can carry correlated data, since the signals transmitted on the orthogonal polarization planes will be uncorrelated even though the data in the signals can be correlated. In some aspects, a wireless communication device can be configured to only transmit on three antennas when uncorrelated data is not available to allow Vz1 and Vz2 to transmit with uncorrelated data. In other aspects, a space-time block code (STBC) can be used by a wireless communication device to create streams for Vz1 and Vz2,

In some aspects, a wireless communication device can perform beamforming by using correlated signals at an antenna array, such as in environments with available scattering surfaces. Correlated signals in beamforming are likely to cause constructive interference at random points in space, resulting in a need to reduce the power to individual antenna elements by a back off amount to meet power restriction thresholds. As detailed above, radiating beamforming signals in independent polarization planes results in uncorrelated signals from the transmitting device prior to the signals scattering. Correlation between signals in different polarization planes is represented by a metric referred to as cross-polarization discrimination. Prior to scattering, polarization diversity from orthogonal antennas results in large cross polarization discrimination (e.g., greater than 20 decibels (dB)). After repeated reflections (e.g., due to an indoor environment with many surfaces for scattering), signals are attenuated, and both co-polarized and cross-polarized (e.g., from orthogonal antennas) have similar received signal strength indication (RSSI) distributions at receiver antennae. Further, the cross-polarization discrimination described above becomes diminishingly small (e.g., reduces from 20 dB to 0 dB), matching the cross-polarization discrimination from co-polarized transmissions (e.g., transmitted from antennas in the same orientation). Reflections (e.g., scattered signals) from objects in an environment can thus be constructively combined at a receiver with sufficient reflective surfaces. By using cross-polarized but correlated signals, unwanted constructive interference can be avoided near a transmitter, but desired constructive interference can be achieved at a receiving device. The receiving and transmitting device in such aspects can function using standard sounding and steering operations. Such a use of cross-polarized antennas can thus enable higher transmission power at a transmitting device, and improved performance and reception of signals at a receiving device in an environment with sufficient scattering, using standard beamforming operations to control the signal from the transmitting device to the receiving device.

In some aspects, a wireless communication device configured for cross-polarization operation can be used in a PSD restricted environment as follows:
Ntx_max=Maximum number of Tx Chains (e.g. 4)
Ntx=No. of Tx chains used for a particular PPDU
Nsts: No. of Space Time Streams used for a particular PPDU
BDF or a static configuration table shall have a field for Polarization Diversity Enabled/Disabled

If disabled (e.g., if the AP does not support Polarization Diversity), the control (e.g., CTL) tables will be used as per the Ntx assignment rules below,
For Data packets, if (BF=1), then Ntx=Ntx_max, Else Ntx=Nsts
For Management Packets, Ntx=1, legacy 11a
For Beacons: Ntx=1, Legacy 11a, 6 Mbps, 20M
For CTS packets: Ntx=1, to be sent in 6 Mbps, legacy 11a or in non-ht-duplicate

If enabled (If the AP supports Polarization Diversity), the CTL tables will be used as per the Ntx assignment rules below,
Chain Mask from the BDF for Ntx=3 into ‘BDF_Tx_Chain_Mask’ based on the antenna polarization & associated RF Chain: Vz1, Hx, Vz2, Hy (e.g., 0x1101) (e.g., BDF_Tx_Chain_Mask specifies which of the NTxmax antennas are to be used in a transmission).

For Data packets,

if (BF == 1) && ( Nsts >= 3), Then ( Ntx = Ntx_max )
Else Ntx = 3, Tx_chain_mask = BDF_Tx_Chain_Mask
For Management packets, Ntx = 3
For Beacons: Ntx = 3, Legacy 11a, 6Mbps, 20M
For CTS packets: Ntx = 3, 6Mbps, legacy 11a or in non-ht-duplicate

Table 1 below specifies the Tx Power the transmitter is capable of generating based on various criteria, such as EVM, spectral masks, etc., for various types of transmission (e.g., modulation and coding scheme (MCS), BW, single user/multiuser (SU/MU), etc.). Table 1 illustrates the performance of transmissions by a wireless communication device in mid-range performance in accordance with some aspects. Certain transmissions are limited by control table power limits. For 4×1 and 4×2 operations, per antenna transmit power is limited to between 11.5 and 14.5 dBm without polarization diversity as described herein. With polarization diversity, a gain of 3 dB is seen, and other power limits increase as well.

TABLE 1
6G (DPD OFF/ON) - No power changes

| | 20 | | 40 | | 80 | | 160 | |
|---|---|---|---|---|---|---|---|---|
| | _{——}SU_{——} | _{——}MU_{——} | _{——}SU_{——} | _{——}MU_{——} | _{——}SU_{——} | _{——}MU_{——} | _{——}SU_{——} | _{——}MU_{——} |
| MCS0 | 24 | 24 | 23 | 23 | 23 | 23 | 22 | 22 |
| MCS1 | 24 | 24 | 23 | 23 | 23 | 23 | 22 | 22 |
| MCS2 | 24 | 24 | 23 | 23 | 23 | 23 | 22 | 22 |
| MCS3 | 24 | 24 | 23 | 23 | 23 | 23 | 22 | 22 |
| MCS4 | 24 | 21 | 23 | 21 | 23 | 21 | 22 | 21 |
| MCS5 | 23 | 21 | 23 | 21 | 23 | 21 | 22 | 21 |
| MCS6 | 21 | 19.5 | 21 | 19.5 | 21 | 19.5 | 21 | 19.5 |
| MCS7 | 21 | 19.5 | 21 | 19.5 | 21 | 19.5 | 21 | 19.5 |
| MCS8 | 19.5 | 16 | 19.5 | 16 | 19.5 | 15.5 | 19.5 | 14.5 |
| MCS9 | 19.5 | 16 | 19.5 | 16 | 19.5 | 15.5 | 19.5 | 14.5 |
| MCS10 | 18.5 | 14 | 18.5 | 13.5 | 18.5 | 13.5 | 17.5 | 13 |
| MCS11 | 18.5 | 14 | 18.5 | 13.5 | 18.5 | 13.5 | 17.5 | 13 |
| MCS12 | 16 | 13 | 16 | 12.5 | 15.5 | 12.5 | 14.5 | 12 |
| MCS13 | 16 | 13 | 16 | 12.5 | 15.5 | 12.5 | 14.5 | 12 |

TABLE 2 illustrates an example CTL control table in accordance with some aspects, with data indicating whether polarization diversity is enabled, whether beamforming is enabled (BF), the number of antennas (Ntx), the number of communication streams (Nas), and the channels with associated frequencies and channel bandwidths.

TABLE 2

| | | | | CTL limit 160 | | | | | | | |
|---|---|---|---|---|---|---|---|---|---|---|---|
| Pol | | | | | 6025 channel | | CTL limit 20 | | | | |
| Diversity | BF | Ntx | Nss | 5250 | CTL | 6985 | 5180 | 5260 | 5745 | 5955 | 7115 |
| 0 | 0 | 4 | 1 | 17.5 | 11.5 | 11.5 | 20.0 | 14.0 | 23.5 | 2.0 | 2.0 |
| 0 | 0 | 4 | 2 | 17.5 | 14.5 | 14.5 | 23.0 | 17.0 | 23.5 | 5.0 | 5.0 |
| 0 | 0 | 4 | 3 | 17.5 | 16.5 | 16.5 | 23.0 | 17.0 | 23.5 | 7.0 | 7.0 |
| 0 | 0 | 4 | 4 | 17.5 | 17.5 | 17.5 | 23.0 | 17.0 | 23.5 | 8.0 | 8.0 |
| 0 | 0 | 3 | 1 | 19.0 | 14.0 | 14.0 | 22.5 | 16.5 | 25.0 | 4.5 | 4.5 |
| 0 | 0 | 3 | 2 | 19.0 | 17.0 | 17.0 | 24.5 | 18.5 | 25.0 | 7.5 | 7.5 |
| 0 | 0 | 3 | 3 | 19.0 | 19.0 | 19.0 | 24.5 | 18.5 | 25.0 | 9.5 | 9.5 |
| 0 | 0 | 2 | 1 | 20.5 | 17.5 | 17.5 | 26.0 | 20.0 | 26.5 | 8.0 | 8.0 |
| 0 | 0 | 2 | 2 | 20.5 | 20.5 | 20.5 | 26.0 | 20.0 | 26.5 | 11.0 | 11.0 |
| 0 | 0 | 1 | 1 | 24.0 | 23.5 | 23.5 | 29.0 | 23.0 | 30.0 | 14.0 | 14.0 |
| 0 | 1 | 4 | 1 | 14.5 | 11.5 | 11.5 | 20.0 | 14.0 | 20.5 | 2.0 | 2.0 |
| 0 | 1 | 4 | 2 | 17.5 | 14.5 | 14.5 | 23.0 | 17.0 | 23.5 | 5.0 | 5.0 |
| 0 | 1 | 4 | 3 | 17.5 | 16.5 | 16.5 | 23.0 | 17.0 | 23.5 | 7.0 | 7.0 |
| 0 | 1 | 3 | 1 | 17.0 | 14.0 | 14.0 | 22.5 | 16.5 | 23.0 | 4.5 | 4.5 |
| 0 | 1 | 3 | 2 | 19.0 | 17.0 | 17.0 | 24.5 | 18.5 | 25.0 | 7.5 | 7.5 |
| 0 | 1 | 2 | 1 | 20.5 | 17.5 | 17.5 | 26.0 | 20.0 | 26.5 | 8.0 | 8.0 |
| 1 | 0 | 2 | 1 | 21.0 | 20.5 | 20.5 | 26.0 | 20.0 | 27.0 | 11.0 | 11.0 |
| 1 | 0 | 2 | 2 | 21.0 | 20.5 | 20.5 | 26.0 | 20.0 | 27.0 | 11.0 | 11.0 |
| 1 | 1 | 2 | 1 | 21.0 | 20.5 | 20.5 | 26.0 | 20.0 | 27.0 | 11.0 | 11.0 |
| 1 | 0 | 3 | 1 | 19.2 | 18.7 | 18.7 | 24.2 | 18.2 | 25.2 | 9.2 | 9.2 |
| 1 | 0 | 3 | 2 | 19.2 | 18.7 | 18.7 | 24.2 | 18.2 | 25.2 | 9.2 | 9.2 |
| 1 | 0 | 3 | 3 | 19.2 | 18.7 | 18.7 | 24.2 | 18.2 | 25.2 | 9.2 | 9.2 |
| 1 | 0 | 4 | 4 | 18.0 | 17.5 | 17.5 | 23.0 | 17.0 | 24.0 | 8.0 | 8.0 |
| 1 | 1 | 3 | 1 | 19.2 | 18.7 | 18.7 | 24.2 | 18.2 | 25.2 | 9.2 | 9.2 |
| 1 | 1 | 3 | 2 | 19.2 | 18.7 | 18.7 | 24.2 | 18.2 | 25.2 | 9.2 | 9.2 |
| 1 | 1 | 4 | 3 | 18.0 | 17.5 | 17.5 | 23.0 | 17.0 | 24.0 | 8.0 | 8.0 |
| 1 | 1 | 4 | 4 | 18.0 | 17.5 | 17.5 | 23.0 | 17.0 | 24.0 | 8.0 | 8.0 |

In table 2, the table values other than the diversity flag (e.g., indicating the polarization diversity status) and beamforming flag (e.g., indicating a beamforming use status), and the Ntx and Nss indicators, are power targets per transmission chain. When the polarization diversity value is 0, the array gain will be (10*log 10(Ntx/Nss)). When the polarization diversity value is 1, the array gain will be 0.

In some aspects, a wireless communication device can operate where the static values from a CTL control table such as table 2 can be combined with dynamic data stream (e.g., per-packet) array gain contributions determined in software at a physical (e.g., HALPHY) layer of a device. In some such aspects, an array gain for a wireless communication device can be determined as follows:

Array Gain is distributed between the static (CTL Table) and the dynamic (computed per-packet) contributions as:

$$G\_Array = G\_ ( Static ) . G\_Dyn \qquad ( 1 )$$

The CTL table provides the target power conforming to the regulatory guidelines using Gstatic for a reference antenna configuration. The physical layer computes the GDyn for the actual antenna configuration used, such that Gdyn>=1 (e.g., avoiding accidental violations).

Inputs used for CTL Table generation are the table values described above for a polarization mode and the antenna and communication settings (e.g. Ntx and Nss) along with the channel details.

Cmax represents a maximum (max) modified number of Co-polarized Antenna. Cmax can be determined as per one or more of the following approaches:
In some aspects Cmax is: [symbol] C [symbol] _max=[N_Tx/γ]
For Ntx=3,4,5, Polarization Number=3, Cmax=1
For Ntx=6,7,8, Polarization Number=3, Cmax=2

In some aspects, a single table works for a given polarization Number (e.g., 3 with three orthogonal directions) and given antenna plane configurations (e.g., for 8 antennas: configurations, viz., 3-3-2, 4-3-1, 4-2-2, 5-2-1, 6-1-1).

Similarly, a separate table works for Polarization Number-2 (e.g., for 8 antennas: configurations, viz., 4-4, 5-3, 6-2, 7-1).

In some aspects:
Cmax=[N_Tx/y]: max no. of co-polarized antenna in the optimal antenna configuration.

In some aspects:

C_max=max(N_(Tx,X),N_(Tx,Y),N_(Tx,Z))

Where Cmax=maximum number of co-polarized antenna in the antenna configuration used. A table can be used based on the number of polarization planes present in a device as described above. In some such aspects, a 3-3-2 division of antennas amount the polarization planes is optimal for γ=3 and a 4-4 division of antennas among the polarization planes is optimal for γ=2.

For the examples above, an array Gain used in the CTL table is then:

$$Gstatic , dB = \{ ( 10 * log 10 ( C max / Nss ) , C max > Nss @ 0 , otherwise ) \}$$

Examples of 8 antennas are described above, but in additional aspects, other configurations or different numbers of antennas can be used by a wireless communication device. Table 3 illustrates details of the possible configurations for a device with 8 antennas, with mask-based configurations illustrated in the table. In some aspects, such masks can be signaled in a data packet and used for data signaling with polarization diversity and in some aspects the masks can be used by the MAC to signal to the PHY about the specified antenna to be used for a particular packet.

TABLE 3

| nTxMax = 8 | 8 | | | | | | | | |
|---|---|---|---|---|---|---|---|---|---|
| Polarization No. (γ) | 1 | 2 | | | | 3 | | | |
| Max. no. of Co-polarized antenna | 8 | 4 | 5 | 6 | 7 | 3 | 4 | 5 | 6 |
| in a polarization plane | | | | | | | | | |
| Antenna split | | 4-4 | 5-3 | 6-2 | 7-1 | 3-3-2 | 4-2-2, 4-3-1 | 5-2-1 | 6-1-1 |
| Ref Array Gain (linear) in CTL table | 8 | 4 | 5 | 6 | 7 | 3 | 4 | 5 | 6 |
| generation in present systems | | | | | | | | | |
| Antenna Polarization configuration | | | | | | Vz1, Hx1, Hy1, Vz2, | Vz1, Hx1, Hy1, Vz2, | | |
| | | | | | | Hx2, Hy2, Vz3, Hx3 | Hx2, Hy2, Vz3, Vz4 | | |
| | | | | | | | Vz1, Hx1, Hy1, Vz2, | | |
| | | | | | | | Hx2, Vz3, Hx3, Vz4 | | |
| X-Pol-Mask | | | | | | 01001001 | 01001000 ′01001010 | | |
| Y-Pol-Mask | | | | | | 00100100 | 00100100 ′00100000 | | |
| Z-Pol-Mask | | | | | | 10010010 | 10010011 ′10010101 | | |

| | |
|---|---|
| Data-packet | Ntx = 8: ′11111111 |
| Chain Mask | Ntx = 7: ′11111110, 11111101, 11111011, . . . |
| | Ntx = 6: ′11111100, 11111010, ′11111001, . . . |

For beamforming, additional inputs can be used in computation of an array gain penalty. In some aspects, the inputs used to determine gain penalties in a wireless communication device are the same inputs described above, with the additional polarization mask inputs indicating a specific antenna configuration used on the device for each polarization plane, along with a maximum number of copolarized antenna related to the polarization masks.

In some aspects:

$$\begin{matrix}C max = floor ( sum ( bitsum ( Xm ) , bitsum ( Ym ) , \\ bitsum ( Zm ) ) / Sum ( Xm \sim = 0 , Ym \sim \\ = 0 , Zm \sim = 0 ) )\end{matrix}$$

In some aspects:

$$C max = ceil ( sum ( bitsum ( Xm ) , bitsum ( Ym ) , bitsum ( Zm ) ) \text{} / Sum ( Xm \sim = 0 , Ym ∼ = 0 , Zm ∼ = 0 )$$

In some aspects:

C max=max(bitsum(Xm),bitsum(Ym),bitsum(Zm))

The physical layer can then use the following as inputs to compute the Array Gain Penalty: a Tx Chain Mask (Cm) is determined in firmware for every packet according to the mask as associated with the antenna selection pattern; the control table; and the antenna planes.

A total number of Co-polarized antenna per packet (Amax) is then calculated as:

A max=Max(Bitsum(Xm AND Cm),Bitsum(Ym AND Cm),Bitsum(Zm AND Cm))

The array gain penalty as calculated in firmware is then determined as;

$${G}_{Dyn , dB} = \{ \begin{matrix}10 * log 10 ( \frac{{A}_{max}}{{C}_{max}} ) , & {Ama}_{x} > {Cma}_{x} > Nss \\ 10 * log 10 ( \frac{{A}_{max}}{{N}_{sy}} ) , & {Ama}_{x} > {Ns}_{s} \geq {Cm}_{ax} \\ 0 , & otherwise\end{matrix}$$

Tables 4-9 illustrate additional aspects of possible antenna configurations with associated masks that can be used in configuration polarization diversity communications in accordance with aspects described herein.

TABLE 4
For Antenna Configuration (3-3-2): Vz1, Hx1, Hy1, Vz2, Hx2, Hy2, Vz3, Hx3

| | | | | | | | | | | | | Halphy | | |
|---|---|---|---|---|---|---|---|---|---|---|---|---|---|---|
| | | | | | Array | | | | | | | deduc- | | |
| | | | | | Gain | | | | | | | tion | | |
| | | Array | | | deduc- | | | | | | | based on | | |
| | | Gain | | | tion | | | | | | | Antenna | Total | |
| | | Penalty | Polari- | | used in | | | | | | | configu- | deduc- | XP |
| | | for Nss = 1 | zation | | CTL | Z_mask | X_mask | Y_mask | Z_{—} | X_{—} | Y_{—} | ration | tion | Gain |
| Ntxmax | Ntx | (dB) | Number | Cmax | Table (dB) | AND Cm | AND Cm | AND Cm | sum | sum | sum | 3-3-2 | (dB) | (dB) |
| 8 | 8 | 9.03 | 3 | 2 | 3.01 | 10010010 | 01001001 | 00100100 | 3 | 3 | 2 | 1.76 | 4.77 | 4.26 |
| 8 | 7 | 8.45 | 3 | 2 | 3.01 | 10010010 | 01001000 | 00100100 | 3 | 2 | 2 | 1.76 | 4.77 | 3.68 |
| 8 | 6 | 7.78 | 3 | 2 | 3.01 | 10010000 | 01001000 | 00100100 | 2 | 2 | 2 | 0.00 | 3.01 | 4.77 |
| 8 | 5 | 6.99 | 3 | 1 | 0.00 | 10010000 | 01001000 | 00100000 | 2 | 2 | 1 | 3.01 | 3.01 | 3.98 |
| 8 | 4 | 6.02 | 3 | 1 | 0.00 | 10010000 | 01000000 | 00100000 | 2 | 1 | 1 | 3.01 | 3.01 | 3.01 |
| 8 | 3 | 4.77 | 3 | 1 | 0.00 | 10000000 | 01000000 | 00100000 | 1 | 1 | 1 | 0.00 | 0.00 | 4.77 |
| 8 | 2 | 3.01 | 2 | 1 | 0.00 | 10000000 | 01000000 | 00000000 | 1 | 1 | 0 | 0.00 | 0.00 | 3.01 |
| 8 | 1 | 0.00 | 1 | 1 | 0.00 | 10000000 | 00000000 | 00000000 | 1 | 0 | 0 | 0.00 | 0.00 | 0.00 |
| 4 | 4 | 6.02 | 3 | 1 | 0.00 | 1001 | 0100 | 0010 | 2 | 1 | 1 | 3.01 | 3.01 | 3.01 |
| 4 | 3 | 4.77 | 3 | 1 | 0.00 | 1000 | 0100 | 0010 | 1 | 1 | 1 | 0.00 | 0.00 | 4.77 |
| 4 | 2 | 3.01 | 2 | 1 | 0.00 | 1000 | 0100 | 0000 | 1 | 1 | 0 | 0.00 | 0.00 | 3.01 |
| 4 | 1 | 0.00 | 1 | 1 | 0.00 | 1000 | 0000 | 0000 | 1 | 0 | 0 | 0.00 | 0.00 | 0.00 |

TABLE 5
For Antenna Configuration (3-3-2): Vz1, Hx1, Hy1, Vz2, Hx2, Hy2, Vz3, Hx3

| | | | | | | | | | | | | Halphy | | |
|---|---|---|---|---|---|---|---|---|---|---|---|---|---|---|
| | | | | | | | | | | | | deduc- | | |
| | | Array | | | Array | | | | | | | tion | | |
| | | Gain | | | Gain | | | | | | | based on | | |
| | | Penalty | | | deduc- | | | | | | | Antenna | Total | |
| | | for | Polari- | | tion | | | | | | | configu- | deduc- | XP |
| | | given | zation | | used in | Z_mask | X_mask | Y_mask | Z_{—} | X_{—} | Y_{—} | ration | tion | Gain |
| Ntxmax | Ntx | Nss | Number | Cmax | CTL Table | AND Cm | AND Cm | AND Cm | sum | sum | sum | 3-3-2 | (dB) | (dB) |
| 8 | 8 | 9.03 | 3 | 3 | 4.77 | 10010010 | 01001001 | 00100100 | 3 | 3 | 2 | 0 | 4.77 | 4.26 |
| 8 | 7 | 8.45 | 3 | 3 | 4.77 | 10010010 | 01001000 | 00100100 | 3 | 2 | 2 | 0 | 4.77 | 3.68 |
| 8 | 6 | 7.78 | 3 | 2 | 3.01 | 10010000 | 01001000 | 00100100 | 2 | 2 | 2 | 0 | 3.01 | 4.77 |
| 8 | 5 | 6.99 | 3 | 2 | 3.01 | 10010000 | 01001000 | 00100000 | 2 | 2 | 1 | 0 | 3.01 | 3.98 |
| 8 | 4 | 6.02 | 3 | 2 | 3.01 | 10010000 | 01000000 | 00100000 | 2 | 1 | 1 | 0 | 3.01 | 3.01 |
| 8 | 3 | 4.77 | 3 | 1 | 0.00 | 10000000 | 01000000 | 00100000 | 1 | 1 | 1 | 0 | 0.00 | 4.77 |
| 8 | 2 | 3.01 | 2 | 1 | 0.00 | 10000000 | 01000000 | 00000000 | 1 | 1 | 0 | 0 | 0.00 | 3.01 |
| 8 | 1 | 0.00 | 1 | 1 | 0.00 | 10000000 | 00000000 | 00000000 | 1 | 0 | 0 | 0 | 0.00 | 0.00 |
| 4 | 4 | 6.02 | 3 | 2 | 3.01 | 1001 | 0100 | 0010 | 2 | 1 | 1 | 0 | 3.01 | 3.01 |
| 4 | 3 | 4.77 | 3 | 1 | 0.00 | 1000 | 0100 | 0010 | 1 | 1 | 1 | 0 | 0.00 | 4.77 |
| 4 | 2 | 3.01 | 2 | 1 | 0.00 | 1000 | 0100 | 0000 | 1 | 1 | 0 | 0 | 0.00 | 3.01 |
| 4 | 1 | 0.00 | 1 | 1 | 0.00 | 1000 | 0000 | 0000 | 1 | 0 | 0 | 0 | 0.00 | 0.00 |

TABLE 6
For Antenna Configuration (4-3-1): Vz1, Hx1, Hy1, Vz2, Hx2, Vz3, Hx3, Vz4

| | | | | | | | | | | | | Halphy | | |
|---|---|---|---|---|---|---|---|---|---|---|---|---|---|---|
| | | | | | Array | | | | | | | deduc- | | |
| | | Array | | | Gain | | | | | | | tion | | |
| | | Gain | | | deduc- | | | | | | | based on | | |
| | | Penalty | | | tion | | | | | | | Antenna | Total | |
| | | for | Polari- | | used in | | | | | | | configu- | deduc- | XP |
| | | Nss = 1 | zation | | CTL Table | Z_mask | X_mask | Y_mask | Z_{—} | X_{—} | Y_{—} | ration | tion | Gain |
| Ntxmax | Ntx | (dB) | Number | Cmax | (dB) | AND Cm | AND Cm | AND Cm | sum | sum | sum | 3-3-2 | (dB) | (dB) |
| 8 | 8 | 9.03 | 3 | 2 | 3.01 | 10010101 | 01001010 | 00100000 | 4 | 3 | 1 | 3.01 | 6.02 | 3.01 |
| 8 | 7 | 8.45 | 3 | 2 | 3.01 | 10010100 | 01001010 | 00100000 | 3 | 3 | 1 | 1.76 | 4.77 | 3.68 |
| 8 | 6 | 7.78 | 3 | 2 | 3.01 | 10010101 | 01001000 | 00100100 | 3 | 2 | 1 | 1.76 | 4.77 | 3.01 |
| 8 | 5 | 6.99 | 3 | 1 | 0.00 | 10010000 | 01001000 | 00100000 | 2 | 2 | 1 | 3.01 | 3.01 | 3.98 |
| 8 | 4 | 6.02 | 3 | 1 | 0.00 | 10010000 | 01000000 | 00100000 | 2 | 1 | 1 | 3.01 | 3.01 | 3.01 |
| 8 | 3 | 4.77 | 3 | 1 | 0.00 | 10000000 | 01000000 | 00100000 | 1 | 1 | 1 | 0.00 | 0.00 | 4.77 |
| 8 | 2 | 3.01 | 2 | 1 | 0.00 | 10000000 | 01000000 | 00000000 | 1 | 1 | 0 | 0.00 | 0.00 | 3.01 |
| 8 | 1 | 0.00 | 1 | 1 | 0.00 | 10000000 | 00000000 | 00000000 | 1 | 0 | 0 | 0.00 | 0.00 | 0.00 |
| 4 | 4 | 6.02 | 3 | 1 | 0.00 | 1001 | 0100 | 0010 | 2 | 1 | 1 | 3.01 | 3.01 | 3.01 |
| 4 | 3 | 4.77 | 3 | 1 | 0.00 | 1000 | 0100 | 0010 | 1 | 1 | 1 | 0.00 | 0.00 | 4.77 |
| 4 | 2 | 3.01 | 2 | 1 | 0.00 | 1000 | 0100 | 0000 | 1 | 1 | 0 | 0.00 | 0.00 | 3.01 |
| 4 | 1 | 0.00 | 1 | 1 | 0.00 | 1000 | 0000 | 0000 | 1 | 0 | 0 | 0.00 | 0.00 | 0.00 |

TABLE 7
For Antenna Configuration (4-3-1): Vz1, Hx1, Hy1, Vz2, Hx2, Vz3, Hx3, Vz4

| | | | | | | | | | | | | Halphy | | |
|---|---|---|---|---|---|---|---|---|---|---|---|---|---|---|
| | | | | | | | | | | | | deduc- | | |
| | | Array | | | Array | | | | | | | tion | | |
| | | Gain | | | Gain | | | | | | | based on | | |
| | | Penalty | | | deduc- | | | | | | | Antenna | Total | |
| | | for | Polari- | | tion | | | | | | | configu- | deduc- | XP |
| | | given | zation | | used in | Z_mask | X_mask | Y_mask | Z_{—} | X_{—} | Y_{—} | ration | tion | Gain |
| Ntxmax | Ntx | Nss | Number | Cmax | CTL Table | AND Cm | AND Cm | AND Cm | sum | sum | sum | 3-3-2 | (dB) | (dB) |
| 8 | 8 | 9.03 | 3 | 3 | 4.77 | 10010101 | 01001010 | 00100000 | 14 | 3 | 1 | 1.25 | 6.02 | 3.01 |
| 8 | 7 | 8.45 | 3 | 3 | 4.77 | 10010100 | 01001010 | 00100000 | 3 | 3 | 1 | 0.00 | 4.77 | 3.68 |
| 8 | 6 | 7.78 | 3 | 2 | 3.01 | 10010101 | 01001000 | 00100100 | 3 | 2 | 1 | 1.76 | 4.77 | 3.01 |
| 8 | 5 | 6.99 | 3 | 2 | 3.01 | 10010000 | 01001000 | 00100000 | 2 | 2 | 1 | 0.00 | 3.01 | 3.98 |
| 8 | 4 | 6.02 | 3 | 2 | 3.01 | 10010000 | 01000000 | 00100000 | 2 | 1 | 1 | 0.00 | 3.01 | 3.01 |
| 8 | 3 | 4.77 | 3 | 1 | 0.00 | 10000000 | 01000000 | 00100000 | 1 | 1 | 1 | 0.00 | 0.00 | 4.77 |
| 8 | 2 | 3.01 | 2 | 1 | 0.00 | 10000000 | 01000000 | 00000000 | 1 | 1 | 0 | 0.00 | 0.00 | 3.01 |
| 8 | 1 | 0.00 | 1 | 1 | 0.00 | 10000000 | 00000000 | 00000000 | 1 | 0 | 0 | 0.00 | 0.00 | 0.00 |
| 4 | 4 | 6.02 | 3 | 2 | 3.01 | 1001 | 0100 | 0010 | 2 | 1 | 1 | 0.00 | 3.01 | 3.01 |
| 4 | 3 | 4.77 | 3 | 1 | 0.00 | 1000 | 0100 | 0010 | 1 | 1 | 1 | 0.00 | 0.00 | 4.77 |
| 4 | 2 | 3.01 | 2 | 1 | 0.00 | 1000 | 0100 | 0000 | 1 | 1 | 0 | 0.00 | 0.00 | 3.01 |
| 4 | 1 | 0.00 | 1 | 1 | 0.00 | 1000 | 0000 | 0000 | 1 | 0 | 0 | 0.00 | 0.00 | 0.00 |

TABLE 8
For Antenna Configuration (4-4): Vz1, Hx1, Vz2, Hx2, Vz2, Hx3, Vz4, Hx4

| | | | | | | | | | | | | Halphy | | |
|---|---|---|---|---|---|---|---|---|---|---|---|---|---|---|
| | | | | | | | | | | | | deduc- | | |
| | | | | | Array | | | | | | | tion | | |
| | | Array | | | Gain | | | | | | | based on | | |
| | | Gain | | | deduc- | | | | | | | Antenna | Total | |
| | | Penalty | Polari- | | tion | | | | | | | configu- | deduc- | XP |
| | | for | zation | | used in | Z_mask | X_mask | Y_mask | Z_{—} | X_{—} | Y_{—} | ration | tion | Gain |
| Ntxmax | Ntx | Nss = 1 | Number | Cmax | CTL Table | AND Cm | AND Cm | AND Cm | sum | sum | sum | 3-3-2 | (dB) | (dB) |
| 8 | 8 | 9.03 | 2 | 4 | 6.02 | 10101010 | 01010101 | 00000000 | 4 | 4 | 0 | 0.00 | 6.02 | 3.01 |
| 8 | 7 | 8.45 | 2 | 3 | 4.77 | 10101010 | 01010100 | 00000000 | 4 | 3 | 0 | 1.25 | 6.02 | 2.43 |
| 8 | 6 | 7.78 | 2 | 3 | 4.77 | 10101010 | 01010000 | 00000000 | 4 | 2 | 0 | 1.25 | 6.02 | 1.76 |
| 8 | 5 | 6.99 | 2 | 2 | 3.01 | 10101000 | 01010000 | 00000000 | 3 | 2 | 0 | 1.76 | 4.77 | 2.22 |
| 8 | 4 | 6.02 | 2 | 2 | 3.01 | 10101000 | 01000000 | 00000000 | 3 | 1 | 0 | 1.76 | 4.77 | 1.25 |
| 8 | 3 | 4.77 | 2 | 1 | 0.00 | 10100000 | 01000000 | 00000000 | 2 | 1 | 0 | 3.01 | 3.01 | 1.76 |
| 8 | 2 | 3.01 | 2 | 1 | 0.00 | 10000000 | 01000000 | 00000000 | 1 | 1 | 0 | 0.00 | 0.00 | 3.01 |
| 8 | 1 | 0.00 | 1 | 1 | 0.00 | 10000000 | 00000000 | 00000000 | 1 | 0 | 0 | 0.00 | 0.00 | 0.00 |
| 4 | 4 | 6.02 | 2 | 2 | 3.01 | 1011 | 0100 | 0000 | 3 | 1 | 0 | 1.76 | 4.77 | 1.25 |
| 4 | 3 | 4.77 | 2 | 1 | 0.00 | 1010 | 0100 | 0000 | 2 | 1 | 0 | 3.01 | 3.01 | 1.76 |
| 4 | 2 | 3.01 | 2 | 1 | 0.00 | 1000 | 0100 | 0000 | 1 | 1 | 0 | 0.00 | 0.00 | 3.01 |
| 4 | 1 | 0.00 | 1 | 1 | 0.00 | 1000 | 0000 | 0000 | 1 | 0 | 0 | 0.00 | 0.00 | 0.00 |

TABLE 9
For Antenna Configuration (7-1) Vz1, Vz2, Vz3, Vz4, Vz5, Vz6, Vz7, Hx1

| | | | | | | | | | | | | Halphy | | |
|---|---|---|---|---|---|---|---|---|---|---|---|---|---|---|
| | | | | | | | | | | | | deduc- | | |
| | | | | | Array | | | | | | | tion | | |
| | | Array | | | Gain | | | | | | | based on | | |
| | | Gain | | | deduc- | | | | | | | Antenna | Total | |
| | | Penalty | Polari- | | tion | | | | | | | configu- | deduc- | XP |
| | | for | zation | | used in | Z_mask | X_mask | Y_mask | Z_{—} | X_{—} | Y_{—} | ration | tion | Gain |
| Ntxmax | Ntx | Nss = 1 | Number | Cmax | CTL Table | AND Cm | AND Cm | AND Cm | sum | sum | sum | 3-3-2 | (dB) | (dB) |
| 8 | 8 | 9.03 | 2 | 4 | 6.02 | 11111110 | 00000001 | 00000000 | 7 | 1 | 0 | 2.43 | 8.45 | 0.58 |
| 8 | 7 | 8.45 | 2 | 3 | 4.77 | 11111100 | 00000001 | 00000000 | 6 | 1 | 0 | 3.01 | 7.78 | 0.67 |
| 8 | 6 | 7.78 | 2 | 3 | 4.77 | 11111000 | 00000001 | 00000000 | 5 | 1 | 0 | 2.22 | 6.99 | 0.79 |
| 8 | 5 | 6.99 | 2 | 2 | 3.01 | 11110000 | 00000001 | 00000000 | 4 | 1 | 0 | 3.01 | 6.02 | 0.97 |
| 8 | 4 | 6.02 | 2 | 2 | 3.01 | 11100000 | 00000001 | 00000000 | 3 | 1 | 0 | 1.76 | 4.77 | 1.25 |
| 8 | 3 | 4.77 | 2 | 1 | 0.00 | 11000000 | 00000001 | 00000000 | 2 | 1 | 0 | 3.01 | 3.01 | 1.76 |
| 8 | 2 | 3.01 | 2 | 1 | 0.00 | 10000000 | 00000001 | 00000000 | 1 | 1 | 0 | 0.00 | 0.00 | 3.01 |
| 8 | 1 | 0.00 | 1 | 1 | 0.00 | 10000000 | 00000000 | 00000000 | 1 | 0 | 0 | 0.00 | 0.00 | 0.00 |
| 4 | 4 | 6.02 | 2 | 2 | 3.01 | 1110 | 0001 | 0000 | 3 | 1 | 0 | 1.76 | 4.77 | 1.25 |
| 4 | 3 | 4.77 | 2 | 1 | 0.00 | 1100 | 0001 | 0000 | 2 | 1 | 0 | 3.01 | 3.01 | 1.76 |
| 4 | 2 | 3.01 | 2 | 1 | 0.00 | 1000 | 0001 | 0000 | 1 | 1 | 0 | 0.00 | 0.00 | 3.01 |
| 4 | 1 | 0.00 | 1 | 1 | 0.00 | 1000 | 0000 | 0000 | 1 | 0 | 0 | 0.00 | 0.00 | 0.00 |

For aspects of wireless communication device performance, including beamforming, a polarization plane can be assigned to individual elements of a selected antenna array configuration. Polarization diversity and masks or maps can be added to configuration tables, with control table limits updated based on the particular antenna array configurations. In such aspects, firmware of a wireless communication device can read the table fields and implement operations to determine appropriate Ntx and mask selection. Additional firmware operations can select co-planar or cross-polarized antenna assignments. Such assignments can be fixed or dynamic for a given wireless communication device. The firmware can then further implement a polarization configuration specific probing sequence to assess scattering patterns and manage control of a beam. The wireless communication device can then perform scheduling of beamforming based transmissions based on the specific system configurations.

When smart antenna configurations are combined with MIMO, additional configuration elements can be used. In some aspects, a wireless communication device can operate with a simple antenna selection scheme for smart antenna MIMO configurations can be used in accordance with aspects described above. In some aspects, each polarization plane is selectably configured for cross-polarized transmissions using all available polarization planes per transmission chain. In some aspects, the wireless communication device can configure each transmit chain for use with sectorized polarization domains. The wireless communication device can use generalized optimization with both cross-polarization and simple antenna assignments for different transmit chains. Such aspects can support plane diversity as well as pattern diversity with beamforming and MIMO operations. In some aspects, MIMO implementations in wireless communication devices include a number of antennas equal to the number of transmit and receive chains, so a dedicated antenna (e.g., with an associated polarization) is associated with each chain. In some aspects, smart antennas function as a superset of MIMO operations with antenna arrays (e.g., a set of antennas or antenna elements that can be used for beamforming). Smart antennas may have a number of antennas much larger than the number of transmit or receive chains. In aspects where smart antenna systems support MIMO, a system can configure antenna elements from the available antenna elements for every transmission or receive chain.

In some aspects, a wireless communication device can include M elements and one housing per transmit chain, with the number of combination options L=M×Ntx. If multiple sectors can be excited per housing, then the number of combinations becomes L=Ntx\hat{ }(2\hat{ }M). With such a large number of transmit chain-to-sector mappings, the wireless communication device can use simple rules to select a mapping, such as using identical sectors for each housing.

In some aspects, such as indoor environments with significant scattering, antenna housings of the wireless communication device can be divided into a maximum number of supported polarization planes. For example, with four transmit chains, one housing can be assigned per polarization plane. With eight transmit chains, two antenna housings can be assigned per polarization plane.

Illustrative examples of four antenna implementations include:
Nss=1: Ntxmax=4, Choose Ntx=3, pick one element per housing. Total search space is 3*M=3/4 Q.
Nss=2: Ntxmax=4, Choose Ntx=3, pick one element per housing, Total search space is 3*M=3/4Q.
Nss=3 or 4: Ntxmax=4, Choose Ntx=4, pick one element per housing. Total Search space is Q.

Where the array gain penalty is 0 dB for Nss values 1, 2, or 4, 1.2 dB for Nss values of 3, and effectively 6 dB of power gain is present for Nss of 1 with a net mean gain range between 3 and 5 dBm.

Illustrative examples of eight antenna configurations include:
Nss=1: Choose Ntx=6 Pick one element per housing. Total search space is 3/4Q.
Nss=2: Choose Ntx=6, pick one element per housing, Total search space is 3/4Q
Nss=3: Choose Ntx=6, pick one element per housing.
Nss=4: Choose Ntx=8, pick one element per housing. Total Search space is Q
with an array gain penalty is 3 dB for all these cases, compared with non-polarization diversity implementations having an array gain penalty of 10*log 10(8/Nss)={9,6,4,3} dB for Nss=1:4 respectively.

In some aspects, smart antenna systems of a wireless communication device can dynamically select antenna assignments to polarization planes for any transmission chain. In some such aspects, a smart antenna selection algorithm synthesizes polarization masks dynamically, and selects the polarization masks for given packets. In such aspects, the control table values (e.g., similar to table 2 above) can be static or dynamically determined based on the synthesized polarization masks. Such systems can then compute Cmax, the dynamic chain mask, Amax, and the array gain penalty as described for the examples above.

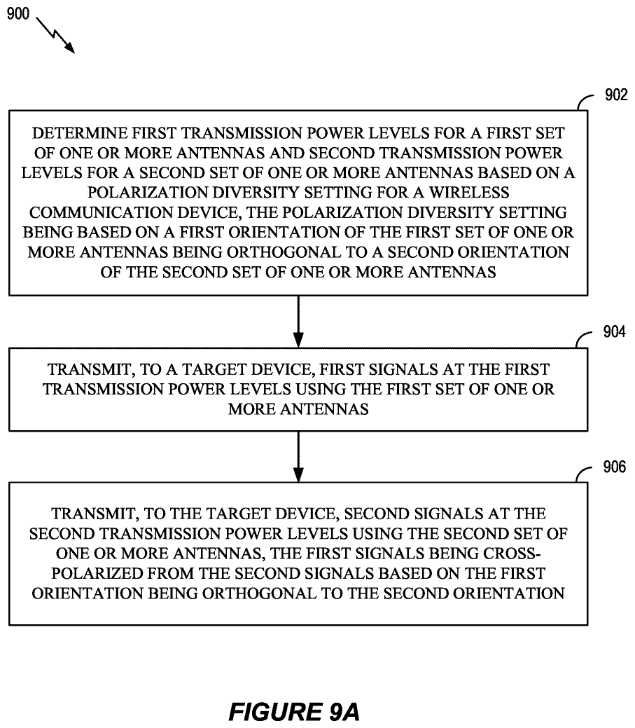

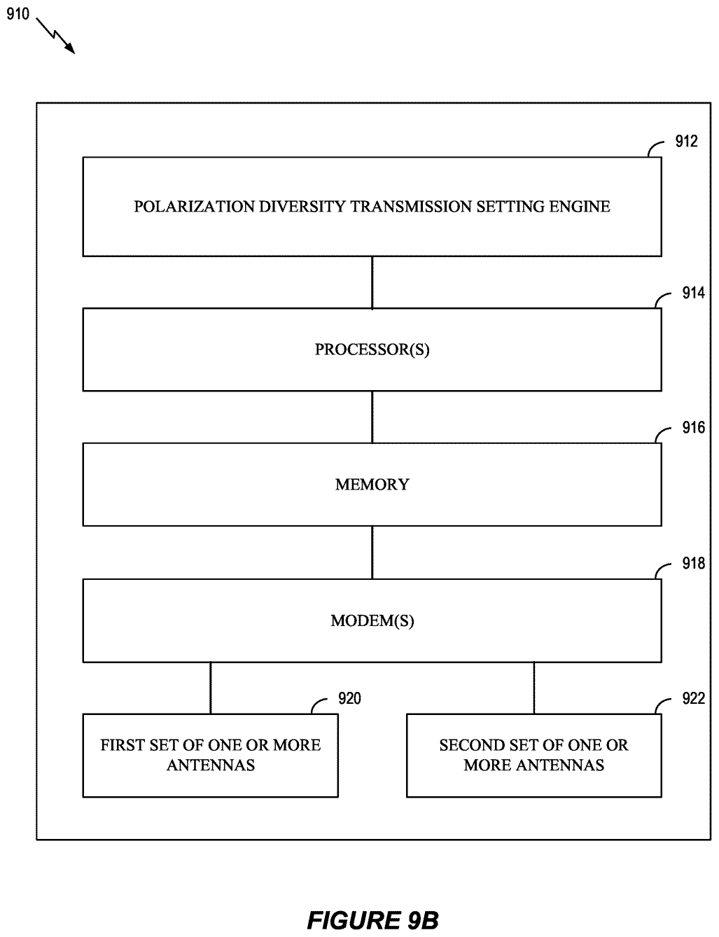

FIG. 9A shows a flowchart illustrating an example process for selection of antenna power levels based on polarization diversity in accordance with aspects described herein. The process 900 illustrates operations that can be performed by a wireless communication device, such as AP 102 (or its components as described herein) or AP 602 (or its components as described herein), as part of transmissions in a communication system. For example, the process 900 may be performed by a wireless communication device, such as one of the STAs 104 described above with reference to FIG. 1, the AP 102 described above with reference to FIG. 1, the AP 602 described above with reference to FIG. 6, or other wireless communication device. FIG. 9B shows a block diagram of an example wireless communication device 910 that is configured to perform the operations of the process 900 of FIG. 9A. In some aspects, the wireless communication device 910 includes a polarization diversity transmission setting engine 912, at least one modem 914, at least one processor 914 communicatively coupled with the at least one modem 918, at least one memory communicatively coupled with the at least one processor 914, a first set of one or more antennas 920 communicatively coupled to the at least one modem 918 and having a first orientation, and a second set of one or more antennas 922 communicatively coupled to the at least one modem 918 and having a second orientation that is orthogonal to the first orientation. The at least one memory 916 stores processor-readable code that, when executed by the at least one processor in conjunction with the at least one modem, is configured to perform the operations of the process 900. In some aspects, the operations of the process 900 can be implemented as instructions in a computer readable storage medium, that, when executed by one or more processors, cause the device to perform the operations illustrated by in the flowchart of FIG. 9.

In some implementations, in block 902, the wireless communication device (e.g., the polarization diversity transmission setting engine 912 of the wireless communication device 910) can determine first transmission power levels for a first set of one or more antennas and second transmission power levels for a second set of one or more antennas based on a polarization diversity setting for a wireless communication device. For example, the polarization diversity setting being based on a first orientation of the first set of one or more antennas being orthogonal to a second orientation of the second set of one or more antennas.

In some implementations, in block 904, the wireless communication device can transmit, to a target device, first signals at the first transmission power levels using the first set of one or more antennas (the first set of one or more antennas 920).

In some implementations, in block 906, the wireless communication device can transmit, to the target device, second signals at the second transmission power levels using the second set of one or more antennas (the first set of one or more antennas 920). The first signals are cross-polarized from the second signals based on the first orientation being orthogonal to the second orientation.

In some aspects, the wireless communication device can determine the polarization diversity setting for one or more communications, the polarization diversity setting indicating that the first signals and the second signals are cross-polarized signals. The wireless communication device can determine antenna assignments for one or more communications at least in part by assigning the first set of one or more antennas and the second set of one or more antennas to the one or more communications. In some aspects, wireless communication device can determine the antenna assignments based on polarization masks configured for a data packet. In some aspects, wireless communication device can determine the antenna assignments based on frame types for the one or more communications. The wireless communication device can further select the first transmission power levels for the first set of one or more antennas and the second transmission power levels for the second set of one or more antennas based on the polarization diversity setting and the antenna assignments.

In some aspects, the wireless communication device can determine a first array gain for the first set of one or more antennas based on the antenna assignments. The wireless communication device can determine a second array gain for the second set of one or more antennas based on the antenna assignments. The wireless communication device can further determine determining a transmission power level for each antenna of the first set of one or more antennas based on the first array gain and for each antenna of the second set of one or more antennas based in the second array gain.

In some aspects, the wireless communication device can compute at least one of the first array gain for the first set of one or more antennas and the second array gain for the second set of one or more antennas using data from a control table associated with the antenna assignments and channels associated with the one or more communications and the antenna assignments. In some examples, the data from the control table includes one or more static values for a configuration of the wireless communication device.

In some aspects, the wireless communication device can compute at least one of the first array gain for the first set of one or more antennas and the second array gain for the second set of one or more antennas using one or more dynamic values from one or more settings for the one or more communications.

In some aspects, a first communication of the one or more communications is assigned to a first antenna of the first set of one or more antennas and a first antenna of the second set of one or more antennas. The wireless communication device can calculate or compute a transmit power for the first antenna of the first set of one or more antennas and the first antenna of the second set of one or more antennas based on a polarization diversity between the first antenna of the first set of one or more antennas and the first antenna of the second set of one or more antennas.

In some aspects, a first communication of the one or more communications is assigned to a first antenna of the first set of one or more antennas and a second antenna of the first set of one or more antennas. The wireless communication device can calculate or compute a transmit power for the first antenna of the first set of one or more antennas and the second antenna of the first set of one or more antennas with a power reduction based on a correlation between signals on the first antenna and the second antenna and a lack of polarization diversity between the first antenna of the first set of one or more antennas and the second antenna of the first set of one or more antennas.

In some aspects, a first communication of the one or more communications is assigned to at least two antennas of the first set of one or more antennas and at least two antennas of the second set of one or more antennas. The wireless communication device can determine a transmit power for each antenna assigned to the first communication based on an associated array gain computed for antennas associated with the first orientation and an associated array gain computed for antennas associated with the second orientation.

In some aspects, the wireless communication device includes third one or more antennas fixed in a third orientation. In such aspects, the first orientation, the second orientation, and the third orientation are mutually orthogonal.

In some aspects, the wireless communication device can compute an array gain for each antenna based on a dynamic per-packet gain contribution determined using a physical layer of the wireless communication device and using a target power from a control table fixed for the wireless communication device based on a reference antenna configuration. For example, the wireless communication device can identify or determine the target power based on a number of the one or more communications, a number of orientations associated with the antenna assignments, a polarization diversity status, and a number of co-polarized antennas for each orientation of the number of orientations.

In one illustrative example, the wireless communication device includes eight antennas distributed among available orientations. In such an example, each of the one or more communications is assigned one antenna from each available orientation. An array gain penalty for each available orientation is 3 decibels (dB).

In some aspects, the wireless communication device can transmit cross-polarized steering and sounding beamforming signals using the first set of one or more antennas and the second set of one or more antennas, wherein the first signals and the second signals are beamformed transmissions based on the steering and sounding beamforming signals.

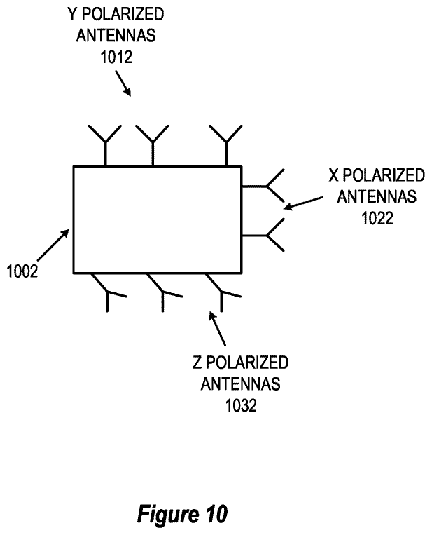

FIG. 10 illustrates an example device 1002 with antennas configured for polarization diversity in accordance with aspects described herein. The deice 1002 can be similar to AP 102, AP 602, or any other such device described herein. As shown in FIG. 6, a device such as AP 602 or device 1002 can have antennas fixed in mutually orthogonal positions, conforming with orthogonal positions 610, 620, and 630. Device 1002 includes three Y polarized antennas 1012 (e.g., in orientation 611), two X polarized antennas 1022 (e.g., in orientation 621), and three Z polarized antennas 1032 (e.g., in orientation 631). As described herein devices can include different numbers of antennas or antenna arrays in different implementations. Device 1002 of FIG. 10 includes eight antennas, and device 1302 described below includes antenna arrays, but a single device can have both individual antennas and antenna arrays in any number or combination of mutually orthogonal orientation.

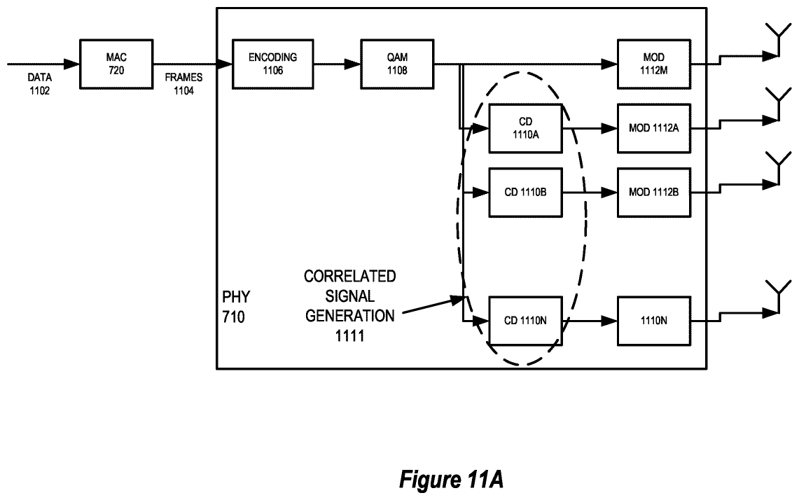

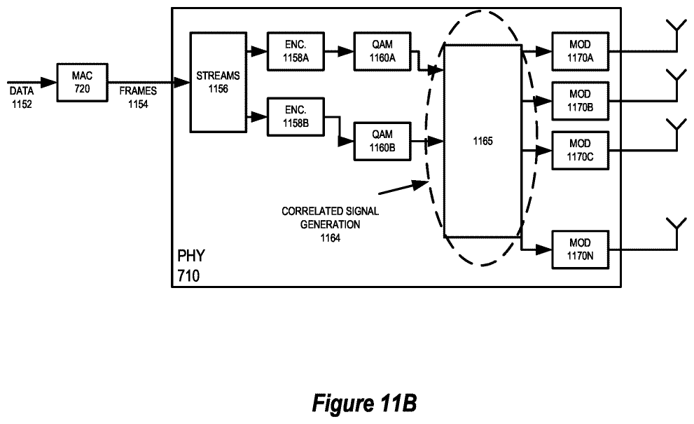

FIG. 11A illustrates aspects of a device configured for antenna array gain setting based on polarization diversity according to some implementations. The device can be device 1002 or any other such device that can be configured for generation of a single stream of correlated signal data that is then used with gain selection based on polarization diversity. Similar to the data flow illustrated in FIG. 7B, in FIG. 11A, data 1102 is provided to MAC 720, which outputs frames 1104. The frames are provided to PHY 710 which performs encoding 1106, and quadrature amplitude modulation 1108. The data is then divided into multiple streams for correlated signal generation 1111 of multiple streams of data. The different streams of data are subject to cyclic delay using CD 1110A-N for each of the streams of data except one (e.g., which has 0 cyclic delay). All of the streams of data are then subject to OFDM modulation for transmission via antennas 1190, which can be the set of antennas 1012, 1022, and 1032 of device 1002. The power settings for each antenna can be determined by a device as described above to meet power limits based on the particular configuration of mutually orthogonal antenna orientation and for the antennas being used for transmission of the correlated signals.

FIG. 11B illustrates aspects of a device configured for antenna array gain setting based on polarization diversity according to some implementations. FIG. 11B is similar to FIG. 11A, with the correlated signal generated from a multi-stream channel in FIG. 11B instead of the single stream of FIG. 11A. In FIG. 11B, data 1152 is a multi-stream channel of data that is processed by MAC 720 to generate frames 1154. The frames are processed by PHY 710 to generate streams 1156 which are separately encoded in encoding 1158A and 1158B. Each separately encoded stream (e.g., of the multiple streams) is subject to QAM 1160A, 1160B. The separate streams are then subject to spatial expansor or beamforming weight matrix processing 1165 for correlated signal generation 1164. The output correlated signals from processing 1165 are then individually subject to separate OFDM modulation 1170A-N (e.g., for each stream of the correlated signals). The streams are then output for transmission on antennas. Just as above, the power settings for each antenna can be determined by a device as described above to meet power limits based on the particular configuration of mutually orthogonal antenna orientation and for the antennas being used for transmission of the correlated signals.

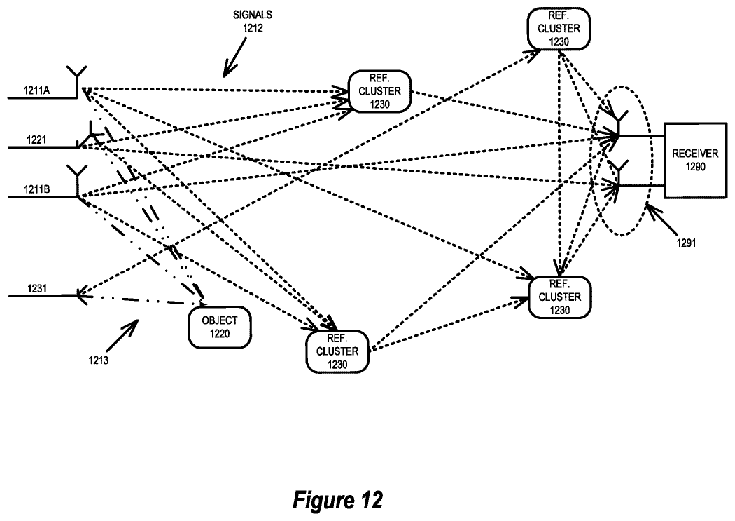

FIG. 12 illustrates system operation including a transmitting device configured for antenna array gain setting based on polarization diversity and a receiving device configured to receive transmissions from the transmitting device according to some implementations. In FIG. 12. In FIG. 12, four antennas are shown with antennas 1211A and 1211B including a shared polarization with the antennas at a first orientation, and antennas 1221 and 1231 having mutually orthogonal orientations with each other and antennas 1211A and 1211B. The transmitted signals from these antennas 1211A, 1211B, 1221, 1231 combine in complex ways as then propagate. An object 1220 that is sensitive to electromagnetic radiation can be subject to unintential beamforming, particularly from the co-polarized correlated signals transmit from antennas 1211A and 1211B. The cross-polarized signals, however, as will not combine as beamformed signals at object 1220, thus limiting the amount of electromagnetic exposure that sensitive object 1220 is exposed to due to the transmissions from antennas 1211A, 1211B, 1221, 1231. The total power that can be transmitted from antennas 1211A, 1211B, 1221, 1231 can therefore be higher while meeting associated exposure limits (e.g., for object 1220) due to the cross-polarization of signals 1212 from antennas 1211A, 1211B, 1221, 1231. In a rich scattering environment, the signals 1212 reflect at reflection clusters 1230. Such reflections depolarize the separate signals from mutually orthogonal antennas, such that at copolarized antennas 1291, signals 1212 from 1211A, 1211B, 1221, 1231 no longer include cross-polarized signals, and so the signals from all antennas 1211A, 1211B, 1221, 1231 can be received as beamformed signals at receiver 1290, where only copolarized signals from co-aligned antennas 1211A and 1211B are received as beamformed signals at object 1220. The difference is due to the loss of polarization when signals 1212 reflect at reflection clusters 1230.

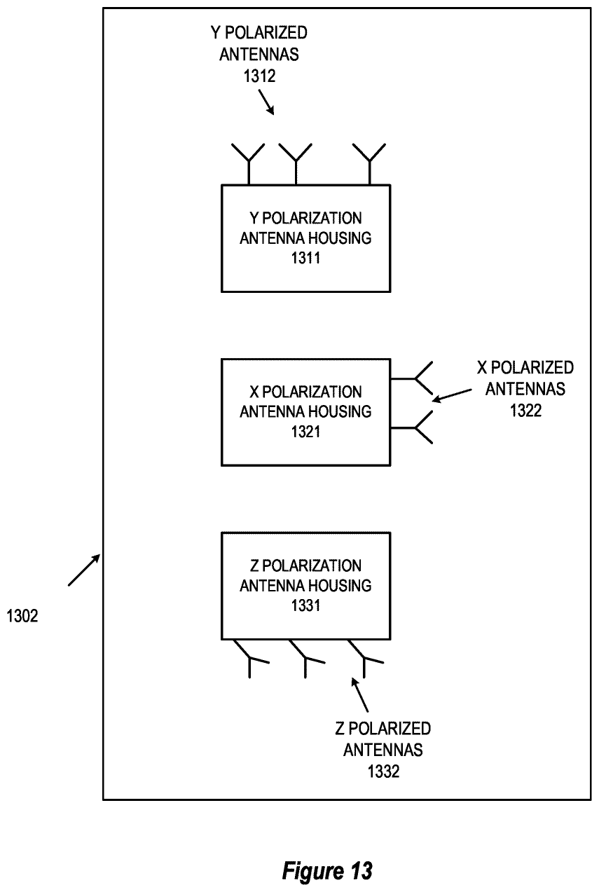

FIG. 13 illustrates an example device with antenna arrays configured for polarization diversity in accordance with aspects described herein. Device 1302 can be similar to device 1002, AP 102, or AP 602, but with three mutually orthogonally oriented antenna arrays in Y polarization antenna housing 1311, X polarization antenna housing 1321, and Z polarization antenna housing 1331. As described herein, such antenna housings with sectorized and mutually orthogonal groupings of antennas can be used as smart antennas for beamforming and MIMO transmission of signals with antenna gain set based on polarization diversity as described herein.

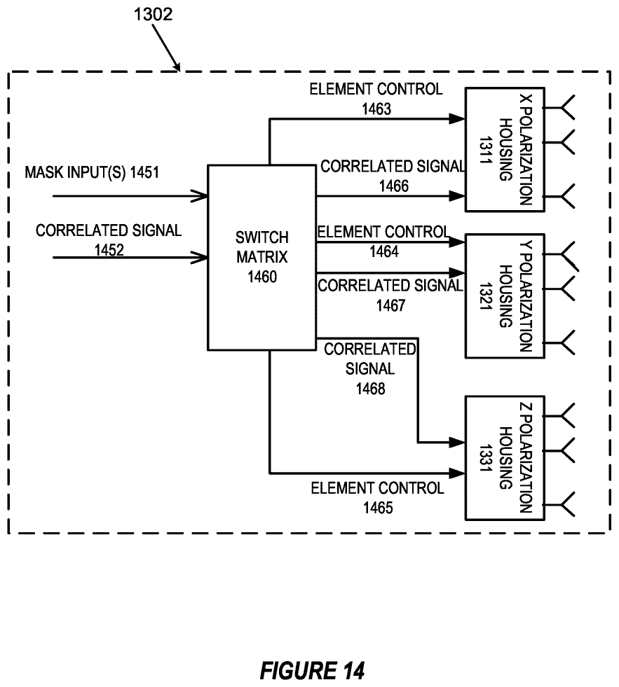

FIG. 14 illustrates aspects of a device configured for antenna array gain setting based on polarization diversity according to some implementations. FIG. 14 illustrates processing of signals for each chain 1402 of a device such as device 1302 to transmit signals based on polarization diversity. In FIG. 14, a chain path includes mask inputs 1451 and correlated signal data 1452, which can be generated as described above with respect to FIG. 7B and mask tables. The mask inputs 1451 can identify both polarization assignments, antenna group assignments, and housing mask assignments, or any other such antenna assignments for data to be transmitted via a device. Switch matrix 1460 separates the correlated signals according the antenna selection identified by mask inputs 1451, with an element control and a corresponding correlated signal for each antenna housing. In the example of FIG. 14, this includes element control 1463 and correlated signal 1466 for Y polarization housing 1311; element control 1464 and correlated signal 1467 for X polarization housing 1321, and element control 1465 and correlated signal 1468 for Z polarization housing 1331. As described herein, the separate element controls and signals can be used for smart antenna beamforming and MIMO operations, including sounding and directional beamforming adjustments to improve transmission performance, in addition to gain setting based on polarization diversity between antenna arrays of the cross-polarized antenna housings.

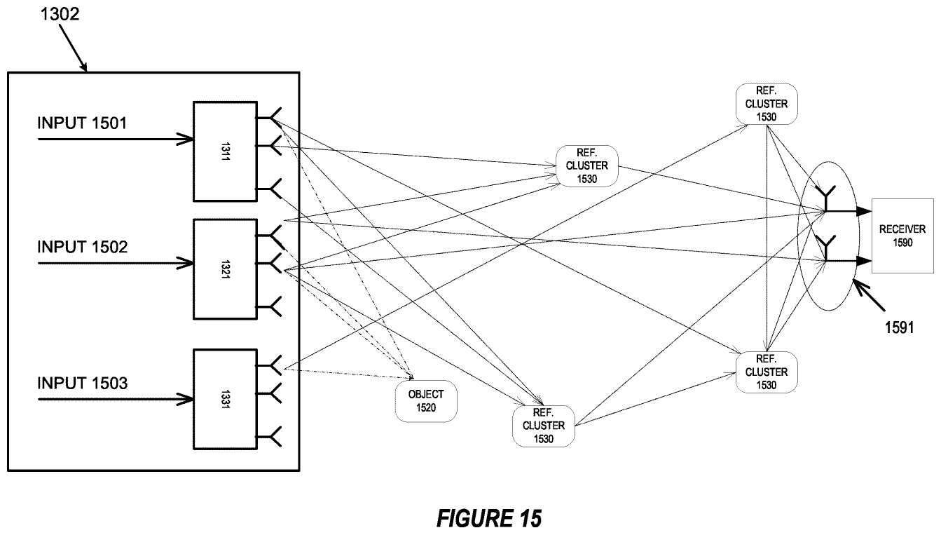

FIG. 15 illustrates system operation including a transmitting chain 1402 configured for antenna array gain setting based on polarization diversity and a receiving device configured to receive transmissions from the transmitting device according to some implementations. Similar to the transmission of FIG. 12, FIG. 14 illustrates operation of transmit chain 1402 in a reflection rich environment. Just as described for other polarization diversity operations, in FIG. 15 inputs 1501, 1502, and 1503 (e.g., corresponding to the correlated signals 1466, 1467, and 1468 of FIG. 14) are transmitted via mutually orthogonal (e.g., cross polarized) antenna arrays of antenna array housings 1311, 1321, and 1331. As the cross polarized signal propagate, they do not combine constructively near transmit chain 1402 at sensitive object 1520 due to the cross-polarization. As the signals propagate further and reflect at reflection clusters 1530, the cross-polarization is lost and the signals can constructively combine (e.g., beamform) at co-polarized antennas 1591 for processing at receiver 1590 of a receiving device. As described herein, beamforming techniques to improve the constructive combination of the signals at antennas 1591 can be used for the transmitted signals (e.g., sounding and other beamforming techniques). Such operations can combine smart antenna operation with improved transmit power while remaining within power transmission regulations due to the cross-polarization of signals from mutually orthogonal antennas (e.g., polarization diversity).

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the examples of: a only, b only, c only, a combination of a and b, a combination of a and c, a combination of b and c, and a combination of a and b and c.

The various illustrative components, logic, logical blocks, modules, circuits, operations and algorithm processes described in connection with the aspects disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the aspects described in this disclosure may be readily apparent to persons having ordinary skill in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Various features that are described in this specification in the context of separate aspects also can be implemented in combination in a single aspect. Conversely, various features that are described in the context of a single aspect also can be implemented in multiple aspects separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

Illustrative aspects of the present disclosure include:

Aspect 1: A wireless communication device, comprising: at least one modem; a first set of one or more antennas communicatively coupled to the at least one modem and having a first orientation; a second set of one or more antennas communicatively coupled to the at least one modem and having a second orientation that is orthogonal to the first orientation; at least one processor communicatively coupled with the at least one modem; and at least one memory communicatively coupled with the at least one processor and storing processor-readable code that, when executed by the at least one processor in conjunction with the at least one modem, is configured to: determine first transmission power levels for the first set of one or more antennas and second transmission power levels for the second set of one or more antennas based on a polarization diversity setting for the wireless communication device, the polarization diversity setting being based on the first orientation of the first set of one or more antennas being orthogonal to the second orientation of the second set of one or more antennas; transmit, to a target device, first signals at the first transmission power levels using the first set of one or more antennas; and transmit, to the target device, second signals at the second transmission power levels using the second set of one or more antennas, the first signals being cross-polarized from the second signals based on the first orientation being orthogonal to the second orientation.

Aspect 2: The wireless communication device of Aspect 1, wherein the processor-readable code, when executed by the at least one processor in conjunction with the at least one modem, is further configured to: determine the polarization diversity setting for one or more communications, the polarization diversity setting indicating that the first signals and the second signals are cross-polarized signals; determine antenna assignments for one or more communications at least in part by assigning the first set of one or more antennas and the second set of one or more antennas to the one or more communications; and select the first transmission power levels for the first set of one or more antennas and the second transmission power levels for the second set of one or more antennas based on the polarization diversity setting and the antenna assignments.

Aspect 3: The wireless communication device of Aspect 2, wherein the processor-readable code, when executed by the at least one processor in conjunction with the at least one modem, is further configured to: determine a first array gain for the first set of one or more antennas based on the antenna assignments; determine a second array gain for the second set of one or more antennas based on the antenna assignments; and determine a transmission power level for each antenna of the first set of one or more antennas based on the first array gain and for each antenna of the second set of one or more antennas based in the second array gain.

Aspect 4: The wireless communication device of Aspect 3, wherein the processor-readable code, when executed by the at least one processor in conjunction with the at least one modem, is further configured to: compute at least one of the first array gain for the first set of one or more antennas and the second array gain for the second set of one or more antennas using data from a control table associated with the antenna assignments and channels associated with the one or more communications and the antenna assignments.

Aspect 5: The wireless communication device of Aspect 4, wherein the data from the control table includes one or more static values for a configuration of the wireless communication device.

Aspect 6: The wireless communication device of any of Aspects 3 to 5, wherein the processor-readable code, when executed by the at least one processor in conjunction with the at least one modem, is further configured to: compute at least one of the first array gain for the first set of one or more antennas and the second array gain for the second set of one or more antennas using one or more dynamic values from one or more settings for the one or more communications.

Aspect 7: The wireless communication device of any of Aspects 1 to 6, wherein a first communication of the one or more communications is assigned to a first antenna of the first set of one or more antennas and a first antenna of the second set of one or more antennas, and wherein a transmit power for the first antenna of the first set of one or more antennas and the first antenna of the second set of one or more antennas is calculated based on a polarization diversity between the first antenna of the first set of one or more antennas and the first antenna of the second set of one or more antennas.

Aspect 8: The wireless communication device of any of Aspects 1 to 6, wherein a first communication of the one or more communications is assigned to a first antenna of the first set of one or more antennas and a second antenna of the first set of one or more antennas.

Aspect 9: The wireless communication device of Aspect 8, wherein a transmit power for the first antenna of the first set of one or more antennas and the second antenna of the first set of one or more antennas is calculated with a power reduction based on a correlation between signals on the first antenna and the second antenna and a lack of polarization diversity between the first antenna of the first set of one or more antennas and the second antenna of the first set of one or more antennas.

Aspect 10: The wireless communication device of Aspect 1 to 6, wherein a first communication of the one or more communications is assigned to at least two antennas of the first set of one or more antennas and at least two antennas of the second set of one or more antennas.

Aspect 11: The wireless communication device of Aspect 10, wherein transmit power for each antenna assigned to the first communication is determined based on an associated array gain computed for antennas associated with the first orientation and an associated array gain computed for antennas associated with the second orientation.

Aspect 12: The wireless communication device of any of Aspects 1 to 11, further comprising: third one or more antennas fixed in a third orientation and communicatively coupled to the at least one modem, wherein the first orientation, the second orientation, and the third orientation are mutually orthogonal.

Aspect 13: The wireless communication device of any of Aspects 2 to 12, wherein the processor-readable code, when executed by the at least one processor in conjunction with the at least one modem, is further configured to: compute an array gain for each antenna based on a dynamic per-packet gain contribution determined using a physical layer of the wireless communication device and using a target power from a control table fixed for the wireless communication device based on a reference antenna configuration, the target power identified based on a number of the one or more communications, a number of orientations associated with the antenna assignments, a polarization diversity status, and a number of co-polarized antennas for each orientation of the number of orientations.

Aspect 14: The wireless communication device of any of Aspects 1 to 13, wherein the wireless communication device includes eight antennas distributed among available orientations, wherein each of the one or more communications is assigned one antenna from each available orientation, and wherein an array gain penalty for each available orientation is 3 decibels (dB).

Aspect 15: The wireless communication device of any of Aspects 2 to 14, wherein the antenna assignments are determined based on polarization masks configured for a data packet.

Aspect 16: The wireless communication device of any of Aspects 2 to 15, wherein the antenna assignments based on frame types for the one or more communications.

Aspect 17: The wireless communication device of any of Aspects 1 to 16, wherein the processor-readable code, when executed by the at least one processor in conjunction with the at least one modem, is further configured to: transmit cross-polarized steering and sounding beamforming signals using the first set of one or more antennas and the second set of one or more antennas, wherein the first signals and the second signals are beamformed transmissions based on the steering and sounding beamforming signals.

Aspect 18: A method for wireless communication transmission, the method comprising: determining first transmission power levels for a first set of one or more antennas and second transmission power levels for a second set of one or more antennas based on a polarization diversity setting for a wireless communication device, the polarization diversity setting being based on a first orientation of the first set of one or more antennas being orthogonal to a second orientation of the second set of one or more antennas; transmitting, to a target device, first signals at the first transmission power levels using the first set of one or more antennas; and transmitting, to the target device, second signals at the second transmission power levels using the second set of one or more antennas, the first signals being cross-polarized from the second signals based on the first orientation being orthogonal to the second orientation.

Aspect 19: The method of Aspect 18, further comprising: determining the polarization diversity setting for one or more communications, the polarization diversity setting indicating that the first signals and the second signals are cross-polarized signals; determining antenna assignments for one or more communications at least in part by assigning the first set of one or more antennas and the second set of one or more antennas to the one or more communications; and selecting the first transmission power levels for the first set of one or more antennas and the second transmission power levels for the second set of one or more antennas based on the polarization diversity setting and the antenna assignments.

Aspect 20: The method of Aspect 19, further comprising: determining a first array gain for the first set of one or more antennas based on the antenna assignments; determining a second array gain for the second set of one or more antennas based on the antenna assignments; and determining a transmission power level for each antenna of the first set of one or more antennas based on the first array gain and for each antenna of the second set of one or more antennas based in the second array gain.

Aspect 21: The method of Aspect 20, further comprising: computing at least one of the first array gain for the first set of one or more antennas and the second array gain for the second set of one or more antennas using data from a control table associated with the antenna assignments and channels associated with the one or more communications and the antenna assignments.

Aspect 22: The method of Aspect 21, wherein the data from the control table includes one or more static values for a configuration of the wireless communication device.

Aspect 23: The method of any of Aspects 20 to 22, further comprising: computing at least one of the first array gain for the first set of one or more antennas and the second array gain for the second set of one or more antennas using one or more dynamic values from one or more settings for the one or more communications.

Aspect 24: The method of any of Aspects 18 to 23, wherein a first communication of the one or more communications is assigned to a first antenna of the first set of one or more antennas and a first antenna of the second set of one or more antennas, and wherein a transmit power for the first antenna of the first set of one or more antennas and the first antenna of the second set of one or more antennas is calculated based on a polarization diversity between the first antenna of the first set of one or more antennas and the first antenna of the second set of one or more antennas.

Aspect 25: The method of any of Aspects 18 to 23, wherein a first communication of the one or more communications is assigned to a first antenna of the first set of one or more antennas and a second antenna of the first set of one or more antennas.

Aspect 26: The method of Aspect 25, wherein a transmit power for the first antenna of the first set of one or more antennas and the second antenna of the first set of one or more antennas is calculated with a power reduction based on a correlation between signals on the first antenna and the second antenna and a lack of polarization diversity between the first antenna of the first set of one or more antennas and the second antenna of the first set of one or more antennas.

Aspect 27: The method of any of Aspects 18 to 23, wherein a first communication of the one or more communications is assigned to at least two antennas of the first set of one or more antennas and at least two antennas of the second set of one or more antennas.

Aspect 28: The method of Aspect 27, wherein transmit power for each antenna assigned to the first communication is determined based on an associated array gain computed for antennas associated with the first orientation and an associated array gain computed for antennas associated with the second orientation.

Aspect 29: The method of any of Aspects 18 to 28, wherein the wireless communication device includes third one or more antennas fixed in a third orientation, wherein the first orientation, the second orientation, and the third orientation are mutually orthogonal.

Aspect 30: The method of any of Aspects 19 to 29, further comprising: computing an array gain for each antenna based on a dynamic per-packet gain contribution determined using a physical layer of the wireless communication device and using a target power from a control table fixed for the wireless communication device based on a reference antenna configuration, the target power identified based on a number of the one or more communications, a number of orientations associated with the antenna assignments, a polarization diversity status, and a number of co-polarized antennas for each orientation of the number of orientations.

Aspect 31: The method of any of Aspects 18 to 30, wherein the wireless communication device includes eight antennas distributed among available orientations, wherein each of the one or more communications is assigned one antenna from each available orientation, and wherein an array gain penalty for each available orientation is 3 decibels (dB).

Aspect 32: The method of any of Aspects 19 to 31, wherein the antenna assignments are determined based on polarization masks configured for a data packet.

Aspect 33: The method of any of Aspects 19 to 32, wherein the antenna assignments based on frame types for the one or more communications.

Aspect 34: The method of any of Aspects 18 to 33, further comprising: transmitting cross-polarized steering and sounding beamforming signals using the first set of one or more antennas and the second set of one or more antennas, wherein the first signals and the second signals are beamformed transmissions based on the steering and sounding beamforming signals.

Aspect 35. A computer-readable storage medium storing instructions that, when executed by one or more processors, cause the one or more processors to perform operations according to any of Aspects 1 to 34.

Aspect 36. An apparatus comprising means for performing operations according to any of Aspects 1 to 34.

What is claimed is:

1. A wireless communication device, comprising:
at least one modem;
a first set of one or more antennas communicatively coupled to the at least one modem and having a first orientation;
a second set of one or more antennas communicatively coupled to the at least one modem and having a second orientation that is orthogonal to the first orientation;
at least one processor communicatively coupled with the at least one modem; and
at least one memory communicatively coupled with the at least one processor and storing processor-readable code that, when executed by the at least one processor in conjunction with the at least one modem, is configured to:
determine first transmission power levels for the first set of one or more antennas and second transmission power levels for the second set of one or more antennas based on a polarization diversity setting for the wireless communication device, the polarization diversity setting being based on the first orientation of the first set of one or more antennas being orthogonal to the second orientation of the second set of one or more antennas;
transmit, to a target device, first signals at the first transmission power levels using the first set of one or more antennas; and
transmit, to the target device, second signals at the second transmission power levels using the second set of one or more antennas, the first signals being cross-polarized from the second signals based on the first orientation being orthogonal to the second orientation.

2. The wireless communication device of claim 1, wherein the processor-readable code, when executed by the at least one processor in conjunction with the at least one modem, is further configured to:
determine the polarization diversity setting for one or more communications, the polarization diversity setting indicating that the first signals and the second signals are cross-polarized signals;
determine antenna assignments for one or more communications at least in part by assigning the first set of one or more antennas and the second set of one or more antennas to the one or more communications; and
select the first transmission power levels for the first set of one or more antennas and the second transmission power levels for the second set of one or more antennas based on the polarization diversity setting and the antenna assignments.

3. The wireless communication device of claim 2, wherein the processor-readable code, when executed by the at least one processor in conjunction with the at least one modem, is further configured to:
determine a first array gain for the first set of one or more antennas based on the antenna assignments;
determine a second array gain for the second set of one or more antennas based on the antenna assignments; and
determine a transmission power level for each antenna of the first set of one or more antennas based on the first array gain and for each antenna of the second set of one or more antennas based in the second array gain.

4. The wireless communication device of claim 3, wherein the processor-readable code, when executed by the at least one processor in conjunction with the at least one modem, is further configured to:
compute at least one of the first array gain for the first set of one or more antennas and the second array gain for the second set of one or more antennas using data from a control table associated with the antenna assignments and channels associated with the one or more communications and the antenna assignments.

5. The wireless communication device of claim 4, wherein the data from the control table includes one or more static values for a configuration of the wireless communication device.

6. The wireless communication device of claim 4, wherein the processor-readable code, when executed by the at least one processor in conjunction with the at least one modem, is further configured to:
compute at least one of the first array gain for the first set of one or more antennas and the second array gain for the second set of one or more antennas using one or more dynamic values from one or more settings for the one or more communications.

7. The wireless communication device of claim 4, wherein a first communication of the one or more communications is assigned to a first antenna of the first set of one or more antennas and a first antenna of the second set of one or more antennas, and wherein a transmit power for the first antenna of the first set of one or more antennas and the first antenna of the second set of one or more antennas is calculated based on a polarization diversity between the first antenna of the first set of one or more antennas and the first antenna of the second set of one or more antennas.

8. The wireless communication device of claim 4, wherein a first communication of the one or more communications is assigned to a first antenna of the first set of one or more antennas and a second antenna of the first set of one or more antennas.

9. The wireless communication device of claim 8, wherein a transmit power for the first antenna of the first set of one or more antennas and the second antenna of the first set of one or more antennas is calculated with a power reduction based on a correlation between signals on the first antenna and the second antenna and a lack of polarization diversity between the first antenna of the first set of one or more antennas and the second antenna of the first set of one or more antennas.

10. The wireless communication device of claim 4, wherein a first communication of the one or more communications is assigned to at least two antennas of the first set of one or more antennas and at least two antennas of the second set of one or more antennas.

11. The wireless communication device of claim 10, wherein transmit power for each antenna assigned to the first communication is determined based on an associated array gain computed for antennas associated with the first orientation and an associated array gain computed for antennas associated with the second orientation.

12. The wireless communication device of claim 2, further comprising:
third one or more antennas fixed in a third orientation and communicatively coupled to the at least one modem, wherein the first orientation, the second orientation, and the third orientation are mutually orthogonal.

13. The wireless communication device of claim 12, wherein the processor-readable code, when executed by the at least one processor in conjunction with the at least one modem, is further configured to:
compute an array gain for each antenna based on a dynamic per-packet gain contribution determined using a physical layer of the wireless communication device and using a target power from a control table fixed for the wireless communication device based on a reference antenna configuration, the target power identified based on a number of the one or more communications, a number of orientations associated with the antenna assignments, a polarization diversity status, and a number of co-polarized antennas for each orientation of the number of orientations.

14. The wireless communication device of claim 12, wherein the wireless communication device includes eight antennas distributed among available orientations, wherein each of the one or more communications is assigned one antenna from each available orientation, and wherein an array gain penalty for each available orientation is 3 decibels (dB).

15. The wireless communication device of claim 2, wherein the antenna assignments are determined based on polarization masks configured for a data packet.

16. The wireless communication device of claim 2, wherein the antenna assignments based on frame types for the one or more communications.

17. The wireless communication device of claim 1, wherein the processor-readable code, when executed by the at least one processor in conjunction with the at least one modem, is further configured to:
transmit cross-polarized steering and sounding beamforming signals using the first set of one or more antennas and the second set of one or more antennas, wherein the first signals and the second signals are beamformed transmissions based on the steering and sounding beamforming signals.

18. A method for wireless communication transmission, the method comprising:
determining first transmission power levels for a first set of one or more antennas and second transmission power levels for a second set of one or more antennas based on a polarization diversity setting for a wireless communication device, the polarization diversity setting being based on a first orientation of the first set of one or more antennas being orthogonal to a second orientation of the second set of one or more antennas;
transmitting, to a target device, first signals at the first transmission power levels using the first set of one or more antennas; and
transmitting, to the target device, second signals at the second transmission power levels using the second set of one or more antennas, the first signals being cross-polarized from the second signals based on the first orientation being orthogonal to the second orientation.

19. The method of claim 18, further comprising:
determining the polarization diversity setting for one or more communications, the polarization diversity setting indicating that the first signals and the second signals are cross-polarized signals;
determining antenna assignments for one or more communications at least in part by assigning the first set of one or more antennas and the second set of one or more antennas to the one or more communications; and
selecting the first transmission power levels for the first set of one or more antennas and the second transmission power levels for the second set of one or more antennas based on the polarization diversity setting and the antenna assignments.

20. The method of claim 19, further comprising:
determining a first array gain for the first set of one or more antennas based on the antenna assignments;
determining a second array gain for the second set of one or more antennas based on the antenna assignments; and
determining a transmission power level for each antenna of the first set of one or more antennas based on the first array gain and for each antenna of the second set of one or more antennas based in the second array gain.

21. The method of claim 20, further comprising:
computing at least one of the first array gain for the first set of one or more antennas and the second array gain for the second set of one or more antennas using data from a control table associated with the antenna assignments and channels associated with the one or more communications and the antenna assignments.

22. The method of claim 21, wherein the data from the control table includes one or more static values for a configuration of the wireless communication device.

23. The method of claim 21, further comprising:
computing at least one of the first array gain for the first set of one or more antennas and the second array gain for the second set of one or more antennas using one or more dynamic values from one or more settings for the one or more communications.

24. The method of claim 21, wherein a first communication of the one or more communications is assigned to a first antenna of the first set of one or more antennas and a first antenna of the second set of one or more antennas, and wherein a transmit power for the first antenna of the first set of one or more antennas and the first antenna of the second set of one or more antennas is calculated based on a polarization diversity between the first antenna of the first set of one or more antennas and the first antenna of the second set of one or more antennas.

25. The method of claim 21, wherein a first communication of the one or more communications is assigned to a first antenna of the first set of one or more antennas and a second antenna of the first set of one or more antennas.

26. The method of claim 25, wherein a transmit power for the first antenna of the first set of one or more antennas and the second antenna of the first set of one or more antennas is calculated with a power reduction based on a correlation between signals on the first antenna and the second antenna and a lack of polarization diversity between the first antenna of the first set of one or more antennas and the second antenna of the first set of one or more antennas.

27. The method of claim 21, wherein a first communication of the one or more communications is assigned to at least two antennas of the first set of one or more antennas and at least two antennas of the second set of one or more antennas.

28. The method of claim 27, wherein transmit power for each antenna assigned to the first communication is determined based on an associated array gain computed for antennas associated with the first orientation and an associated array gain computed for antennas associated with the second orientation.

29. The method of claim 19, wherein the wireless communication device includes third one or more antennas fixed in a third orientation, wherein the first orientation, the second orientation, and the third orientation are mutually orthogonal.

30. The method of claim 29, further comprising:
computing an array gain for each antenna based on a dynamic per-packet gain contribution determined using a physical layer of the wireless communication device and using a target power from a control table fixed for the wireless communication device based on a reference antenna configuration, the target power identified based on a number of the one or more communications, a number of orientations associated with the antenna assignments, a polarization diversity status, and a number of co-polarized antennas for each orientation of the number of orientations.

31. The method of claim 29, wherein the wireless communication device includes eight antennas distributed among available orientations, wherein each of the one or more communications is assigned one antenna from each available orientation, and wherein an array gain penalty for each available orientation is 3 decibels (dB).

32. The method of claim 19, wherein the antenna assignments are determined based on polarization masks configured for a data packet.

33. The method of claim 19, wherein the antenna assignments based on frame types for the one or more communications.

34. The method of claim 18, further comprising:
transmitting cross-polarized steering and sounding beamforming signals using the first set of one or more antennas and the second set of one or more antennas, wherein the first signals and the second signals are beamformed transmissions based on the steering and sounding beamforming signals.
